(19) United States
(12) Patent Application Publication
(10) Pub. No.: US 2002/0087649 A1
(43) Pub. Date: Jul. 4, 2002

(54) Bounded-deferral policies for reducing the disruptiveness of notifications

(76) Inventor: Eric J. Horvitz, Kirkland, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 09/881,502

(22) Filed: Jun. 14, 2001

Related U.S. Application Data
(63) Continuation-in-part of application No. PCT/US01/08710, filed on Mar. 16, 2001.
(63) Continuation-in-part of application No. PCT/US01/08711, filed on Mar. 16, 2001.
(60) Provisional application No. 60/189,801, filed on Mar. 16, 2000.
(60) Provisional application No. 60/212,296, filed on Jun. 17, 2000.

(51) Int. Cl. G06F 15/16

(52) U.S. Cl. 709/207

(57) ABSTRACT

The present invention relates to a system and methodology for reducing disruption costs associated with notifying a user of messages, automated assistance, and/or alerts. According to one aspect of the present invention, bounded-deferral policies may be employed within a notification platform, wherein one or more messages of varying degrees of assigned and/or context-driven priority are relayed to users with a deferral policy guided by the priority and determined states of the users. Users can define available free states according to such inputs as a calendar and time of day. Lower priority messages can be delayed until a more interruptible period of time for the user such as during a sensed or predicted completion of a task, a break or pause in desktop activities, a break in office collaboration activities (pause in conversation), or reduced driving load, such as coming to a stop (in an automobile setting). Higher priority messages can be immediately forwarded to users or sent after a predetermined time configured by the user.

### REFERENCE TO RELATED APPLICATIONS

This application is a continuation in part of PCT Application Ser. No. PCT/US01/08710, which was filed Mar. 16, 2001, entitled PRIORITIES GENERATION AND MANAGEMENT and of PCT Application Ser. No. PCT/US01/08711, which was filed Mar. 16, 2001, entitled NOTIFICATION PLATFORM ARCHITECTURE, both of which claim the benefit of U.S. Provisional Patent Application Ser. No. 60/189,801, which was filed Mar. 16, 2000, entitled ATTENTIONAL SYSTEMS AND INTERFACES. This application also claims the benefit of U.S. Provisional Patent Application Ser. No. 60/212,296, which was filed Jun. 17, 2000, entitled HEURISTIC COMMUNICATIONS POLICIES FOR A NOTIFICATION PLATFORM.

### TECHNICAL FIELD

The present invention relates generally to computer systems, and more particularly to a system and method to minimize disruptiveness of notifications from various communications modalities via bounded deferral policies associated with a notification platform architecture.

### BACKGROUND OF THE INVENTION

With the growth of computer and information systems, and related network technologies such as wireless and Internet communications, ever increasing amounts of electronic information are communicated, transferred and subsequently processed by users and/or systems. As an example, electronic mail programs have become a popular application among computer users for generating and receiving such information. With the advent of the Internet, for example, exchanging e-mail has become an important factor influencing why many people acquire computers. Within many corporate environments, e-mail has become almost a de facto standard by which coworkers exchange information. However, with the heightened popularity of e-mail and other information transfer systems, problems have begun to appear in regard to managing and processing increasing amounts of information from a plurality of sources.

Among these problems, many users now face a deluge of e-mail and/or other information from which to sort through and/or respond, such that the capability of being able to send, receive and process information has almost become a hindrance to being productive. For example, some users report receiving over 100 e-mail messages a day. With such large numbers of e-mail and other electronic information, it has thus become difficult to manage information according to what is important and what is not as important without substantially expending valuable time to make a personal determination as to the importance. As an example of these determinations, users may have to decide whether messages should be responded to immediately, passed over to be read at a later time, or simply deleted due to non-importance (e.g., junk mail).

Some attempts have been directed to information management problems. For example, attempts have been made to curtail the amount of junk or promotional e-mail that users receive. Additionally, some electronic mail programs provide for the generation of rules that govern how e-mail is managed within the program. For example, a rule providing, “all e-mails from certain coworkers or addresses” or “all e-mails to or from certain addresses” are to be placed in a special folder.

These attempts at limiting certain types of information, however, generally are not directed at the basic problem behind e-mail and other information transfer/reception systems. That is, conventional systems often cause users to manually peruse and check at least a portion of some if not all of their received messages in order to determine which messages should be reviewed or further processed. As described above, this takes time from more productive activities. Thus, with the large quantities of information being received (e.g., voice, e-mail, error messages from desktop computer, guesses relating to useful help or assistance from an application, appointments coming up, stock prices, and so forth), there is a need for a system and methodology to facilitate efficient processing of electronic information while mitigating the costs of disruptions associated therewith.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to a system and methodology for reducing the disruption costs associated with notifying a user of messages and/or alerts. Methods are also provided that can bound losses associated with a deferred transmission of information contained in the notifications. According to one aspect of the present invention, bounded-deferral policies may be employed within a notification platform, wherein one or more messages of varying degrees of assigned and/or context-driven priority are directed toward users according to the priority and determined states of the users. It is noted that the bounded-deferral policies can be viewed as potentially effective approximations of deeper, more precise decision-theoretic analyses. For example, users can define available free states according to such inputs as a calendar and time of day. Lower priority messages can be delayed until a more context-friendly time of the user such as during a lunch break or pause in desktop activities. Higher priority messages can be immediately forwarded to users or sent after a predetermined time configured by the user. Priorities of the associated messages can be assigned via user configurations at the notification platform (e.g., all messages from source A are high and all messages from source B are low), and/or can be assigned by notification sources, wherein messages are tagged or provided a scalar value of priority via a subscription service. Messages may be further summarized and/or journaled according to the assigned priorities.

Context information relating to the user can also be considered when determining whether to notify the user or to delay notification. For example, one set of policies may drive longer notification deferral times if it is determined that the user is in an active conversation as opposed to when conversation is absent. Other detectable contexts can apply to mobile devices such as pagers, cell-phones and hand-held devices, wherein detected contexts can consist of determining whether the device is in a storage or low alerting mode (e.g., vibrate vs. sound). Bounded deferral policies can then be employed to escalate the device alerting capabilities given the priority of a received message until some indication that the message has been received by the user.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block diagram of a notification system utilizing bounded deferral policies in accordance with an aspect of the present invention.

FIG. 2 is a schematic block diagram illustrating a notification schema, user preferences profile and notification system in accordance with an aspect of the present invention.

FIG. 3 is a diagram of a subscription service in accordance with an aspect of the present invention.

FIG. 4 is a diagram of an alternative subscription service in accordance with an aspect of the present invention.

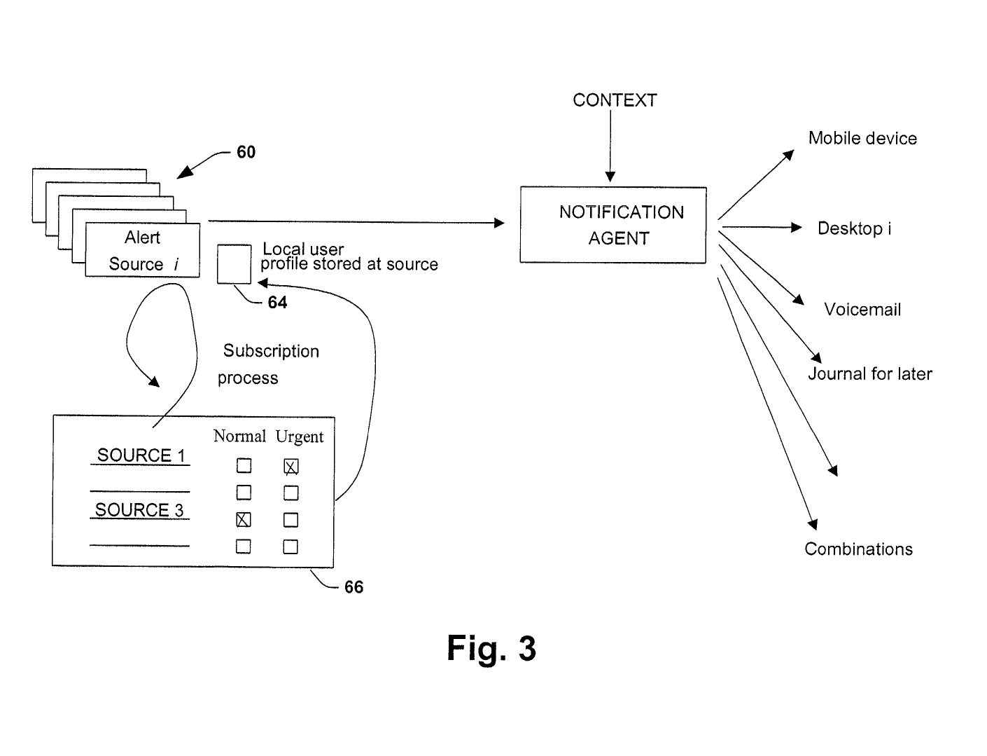

FIG. 3 is a diagram of a subscription service in accordance with an aspect of the present invention.

FIG. 5 is a diagram of a notifications preferences editor in accordance with an aspect of the present invention.

FIG. 6 is a timing diagram of a bounded deferral system in accordance with an aspect of the present invention.

FIG. 7 is a flow diagram of a methodology providing bounded deferral of notifications in accordance with an aspect of the present invention.

FIG. 8 is a flow diagram of a methodology utilized in conjunction with the methodology of FIG. 7 to provide bounded deferral of notifications in accordance with an aspect of the present invention.

FIG. 9 is a diagram illustrating a tool for configuring deferral policies in accordance with an aspect of the present invention.

FIG. 10 is a schematic block diagram of an automated system for assigning message priorities in accordance with an aspect of the present invention.

FIG. 11 is a block diagram illustrating a classifier in accordance with an aspect of the present invention.

FIG. 12 is a schematic block diagram illustrating message classification in accordance with an aspect of the present invention.

FIG. 13 is a schematic block diagram illustrating a scalar classifier output in accordance with an aspect of the present invention.

FIG. 14 is a schematic block diagram illustrating texts classified according to a class and scalar output in accordance with an aspect of the present invention.

FIG. 15 is a diagram illustrating linear and non-linear priorities models in accordance with an aspect of the present invention.

FIG. 16 is a diagram illustrating a model for determining user activity in accordance with an aspect of the present invention.

FIG. 17 is a diagram illustrating an inference-based model for determining current user activity in accordance with an aspect of the present invention.

FIG. 18 is a diagram illustrating an inference-based model for determining alerting costs in accordance with an aspect of the present invention.

FIG. 19 is a diagram illustrating a more detailed inference-based model for determining alerting costs in accordance with an aspect of the present invention.

FIG. 20 is a diagram illustrating a more detailed inference-based model for determining alerting costs in view of a fidelity loss in accordance with an aspect of the present invention.

FIG. 21 is a flow chart diagram illustrating a methodology for generating and determining priorities in accordance with an aspect of the present invention.

FIG. 22 is a diagram illustrating a text generation program and classifier in accordance with an aspect of the present invention.

FIG. 23 is a schematic block diagram illustrating an alerting system in accordance with an aspect of the present invention.

FIG. 24 is a diagram illustrating a routing system and an alerting system in accordance with an aspect of the present invention.

FIG. 25 is a schematic block diagram of a system illustrating a notification platform architecture in accordance with an aspect of the present invention.

FIG. 26 is a schematic block diagram illustrating a context analyzer in accordance with an aspect of the present invention.

FIG. 27 is a schematic block diagram illustrating notification sources and sinks in accordance with an aspect of the present invention.

FIG. 28 is a diagram illustrating a utility of notification curve in accordance with an aspect of the present invention.

FIG. 29 is a diagram illustrating a user specification interface for notifications in accordance with an aspect of the present invention.

FIG. 30 is a diagram illustrating context information sources in accordance with an aspect of the present invention.

FIG. 31 is a diagram illustrating a rules-based system for determining context in accordance with an aspect of the present invention.

FIG. 32 is a schematic block diagram illustrating an inference-based system for determining context in accordance with an aspect of the present invention.

FIG. 33 is a diagram illustrating an inference model for determining context in accordance with an aspect of the present invention.

FIG. 34 is a diagram illustrating a temporal inference model for determining context in accordance with an aspect of the present invention.

FIG. 35 is a flow chart diagram illustrating a methodology for determining context in accordance with an aspect of the present invention.

FIG. 36 is a flow chart diagram illustrating a methodology for notification decision-making in accordance with an aspect of the present invention.

FIG. 37 is a schematic block diagram illustrating a suitable operating environment in accordance with an aspect of the present invention.

FIG. 38 is a schematic block diagram illustrating a suitable operating device in accordance with an aspect of the present invention.

### DETAILED DESCRIPTION OF THE INVENTION

The present invention relates to a notification system and methodology providing user notifications based upon bounded deferral policies that minimize the disruptiveness of the notifications to the user. It is noted that the present invention can be applied to substantially any type of communications, such as the control of incoming communications other than notifications to the user. According to one aspect of the present invention, a context monitor is provided to monitor likely available states of an entity such as a user or system. A bounding system, such as a subscription service or automated priorities system, classifies a notification and/or message to the entity according to a predefined protocol and the likely available states determined by the context monitor. Based upon the likely available states and the classification, user's can be notified presently or the notification can be deferred until a more convenient time for the user. In this manner, disruptiveness costs associated with the notifications are mitigated. Thus, the bounding system facilitates deferral of the notification and/or other communication based at least in part on the notification classification (e.g., urgent, high/low importance).

In accordance with other aspects of the present invention, bounded deferral of communications can be applied to other kinds of tasks, such as physical activity (e.g., using accelerometers or other monitors to discover, say, when a user has stopped bicycling, and is more available for digesting alerts), driving a car (e.g., waiting for a pause in driving load, such as detecting a stop at a stop sign, or a longer pause associated with completing a park or waiting at a red light), and being at a presentation, for example, (e.g., waiting for lots of noise coupled with calendar information about the end of a presentation, when show has concluded). Thus, the present invention can be generalized beyond desktop activity definitions of busy and available-based on sensed and/or predicted completion of a task, a break or pause in desktop activities, a break in office collaboration activities (e.g., pause in conversation), wherein busy and available states can apply to a plurality of diverse activities. As will be described in more detail below, systems can be employed to determine whether a user is in a free/available state, based on timing, forecasting, inference, and/or direct monitoring (e.g., microphones, accelerometers, cameras, and so forth).

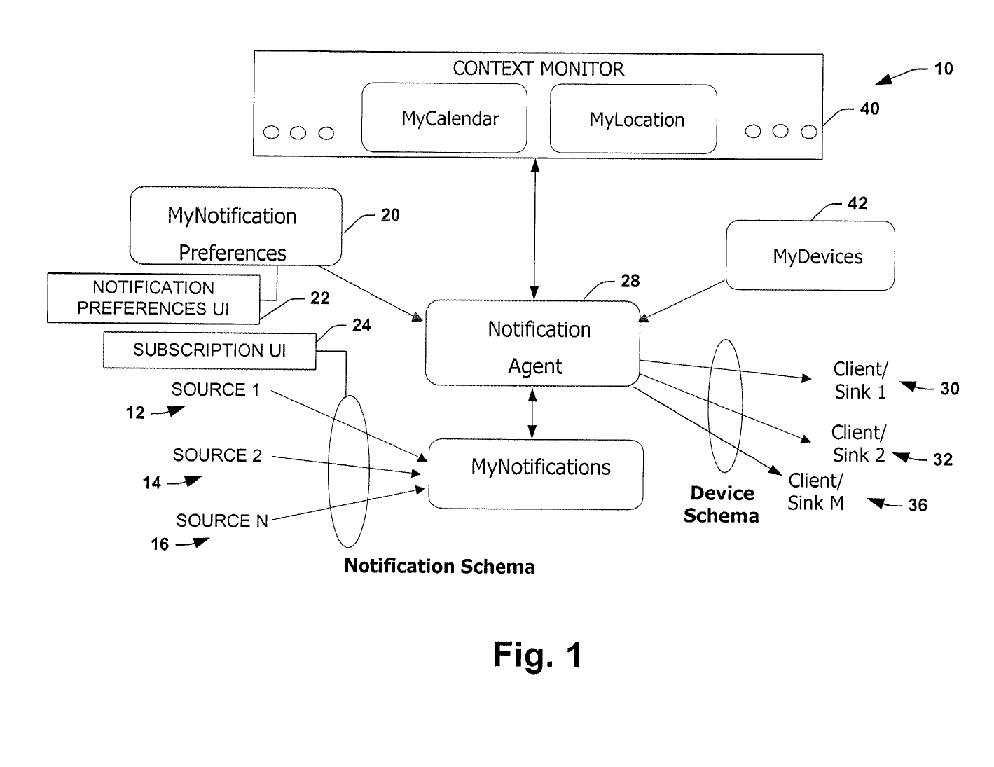

Referring initially to FIG. 1, a notification system 10 illustrates bounded notification deferral in accordance with an aspect of the present invention. Notifications from one or more sources 12-16 can be labeled and/or assigned a high, normal, and low urgency value (or substantially any range of urgency values) by an automated source, by the author of a communication, and/or by a user-specified notification profile 20 (e.g., that examines attributes of a message and/or a message class). A notification preferences user interface 22 is provided to enable a user to adjust or configure the notification profile 20. A subscription user interface 24, can also be provided to enable users to configure an urgency or priority value associated with the sources 12-16.

For example, the sources 12-16 can include Internet sites such as EBAY, MoneyCentral, MSNBC, and/or substantially any message source that can generate information for the user, wherein the subscription user interface 24 can provide priority settings for the respective sources 12-16. As an example, information from the source 12 can be assigned an urgency of medium and information received from source 14 can be assigned an urgency or priority value of high. A notification agent or manager 28 receives the notifications from the sources 12-16 and directs the notifications to one or more clients/sinks 30-36 in accordance with the bounded deferral policies that are described in more detail below. Furthermore, information from one or more context sources monitored within a context monitor 40 are monitored to enable notification decision making within the notification agent 28 in accordance with the bounded deferral policies. The context sources can include calendars, location information, time, acoustical and keyboard activities, as well as a plurality of other context sources that are described in more detail below. The notification agent 28 can also receive information concerning the likely device the user is available to receive messages in a device profile 42.

A list of predefined conditions, relating to user activity, are monitored within the notification agent 28 via the context monitor 40. According to one aspect, the context monitor 40 indicates to the notification agent 28 when the user would likely be in a state to receive notifications; that is, coarser monitoring of context is performed to identify situations, wherein a user would likely be available to receive notifications with minimal disruption. These states, are referred to as “likely available” states. The list can include one or more of the following (and other states)—and are available via the context monitor 40 and/or a computer event sensing system (not shown). This can include monitoring:

User has been present and typing and has just paused typing for x seconds.

User has just saved a file and pauses for x seconds

User has just sent an email and pauses for x seconds

User has just closed an application

User has just switched from one application to another

User has just stopped conversing with someone,

It is to be appreciated that other events and/or conditions can be sensed and/or monitored. For example, the notifications preferences user interface 22 can enable the user to check or uncheck a list of states that define “likely available” states. That is, in a set up control, users can view the following type of list:

I am likely available to review a notification when . . . for example:

[ ] I have just finished typing and have paused for at least [10] seconds.

[ ] I have just sent e-mail.

[ ] I have just saved a document.

[ ] I have finished having a conversation.

These features can be abstracted to include, “ . . . when I have just completed a task,” for example. This can also include a list of likely busy states, as can be appreciated. It is noted that busy and free states can be determined from a plurality of other activities or settings that may or may not be related to desktop activities. For example, other settings can be provided such as: office, and/or general environmental load conditions, such as conversation. Another setting can include a driving setting, such as utilizing information about the nature and type of driving, speed, braking, and so forth to determine whether a user is in a free/available state. This can include changes in thresholds or deferral times as a function of different sub-contexts in one or more of these non-desktop scenarios.

When the likely available states have been identified either automatically or manually, a max deferral time for an urgency level or value is set/configured per respective notification urgency levels. For example, a table can be configured as follows:

Max deferral (High priority notifications): 2 minutes

Max deferral (Normal priority notifications): 7 minutes

Max deferral (Low priority notifications): 15 minutes

This can be set by users, or, alternatively, by system developers for default operation—that may or may not be modified by users). As will be described in more detail below in relation to FIG. 6, notifications are generally sent to the user according to the likely available states for receiving such notifications unless a Max deferral period for the respective notification has expired, in which case the notification is sent at the expiration of the period. Additionally users can be enabled to list exceptions or emergencies as receiving immediate pass-throughs. That is, the user has the ability to state in a rules system, described below, to allow all messages from “my wife”, for example, and/or other designated source to pass through without any deferral whether or not a likely available state is detected.

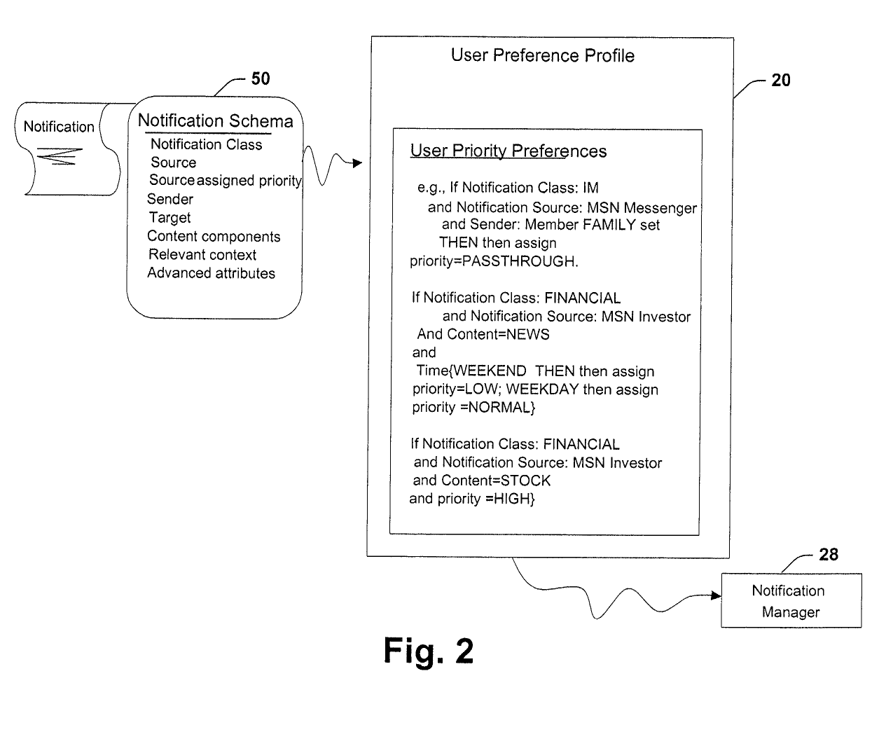

Referring now to FIG. 2, a notification preference profile 20 and a notification schema 50 associated with the sources 12-16 are illustrated in accordance with an aspect of the present invention. As illustrated, the notification preferences profile 20 includes rules and policies for assigning priority values to notifications based upon the notification schema 50. The notification schema 50 defines attributes and values associated with a respective source 12-16. These values within the schema 50 can include a notification class, a source identifier, a source assigned priority value, sender information, target information, message content components, associated notification context, and/or other attributes. Based upon values defined in the schema 50, the notification preferences profile 20 can be configured to provide a determination as to the delivery of notifications from notification sources to notifications sinks. For example the following could be configured:

### EXAMPLE 1

If Notification Class: IM

and Notification Source: Messenger

and Sender: Member Family

THEN assign priority=PASSTHROUGH

### EXAMPLE 2

If Notification Class: Financial

and Notification Source: MSN INVESTOR

and Content=NEWS

and TIME{WEEKEND the assign priority=LOW; WEEKDAY then assign priority=NORMAL}

It is to be appreciated that the present invention is not limited to the above examples and that a plurality of other rules and assignments of priority and combinations thereof can be similarly configured.

The notification schema 50 described above can be provided by a service provider of information that defines attributes and elements for intelligent routing of notifications. The schema 50 can include a notification header defining a notification class, title, and subscription identification (ID). Additionally, notifications can be stamped with a unique ID and time of receipt. Schema information can include whether the notifications were generated by an automated agent or person. The header information can also include volatility information such as time to live and replaceability via a notification update, and also can include whether the notification is replaceable with the same title, class or other designation.

The notification schema 50 can also include information regarding the content or body of the notification. For example, textonly, textAudio, textGraphics, AudioGraphics, as well as other defining information. This can also include how large a notification is (e.g., number of bytes). Moreover, notifications can express an associated value such as a scalar number, a dollar ($$) value, and/or qualitative tags such as high, medium or low, for example. Further expressions can include values that reflect the dynamics in value such as the change in value over time with delays. These dynamics can be communicated via a plurality of functions such as deadlines, stepwise, half-life, and sigmoid functions. In addition, user's can affect the values based upon an associated context determined by the context monitor described above. For example, the user could configure:

### EXAMPLE 3

myCalendar:/myCalendar/today[@time]=‘Important Meeting’

### EXAMPLE 4

myLocation:/electronic/endpoint[@name=“MESSENGER”]/lastUpdate[@value>30 min<90 min].

As previously noted, the present invention is not limited to the illustrated examples. The above configurations can also include boolean expressions such as AND, OR, and NOT.

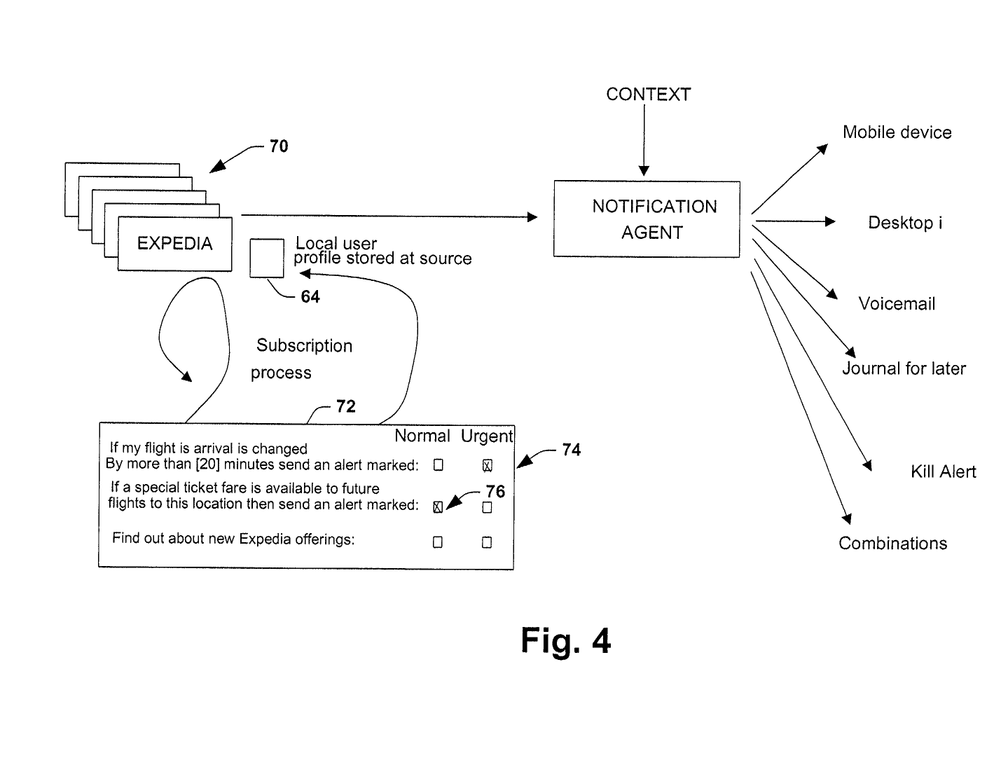

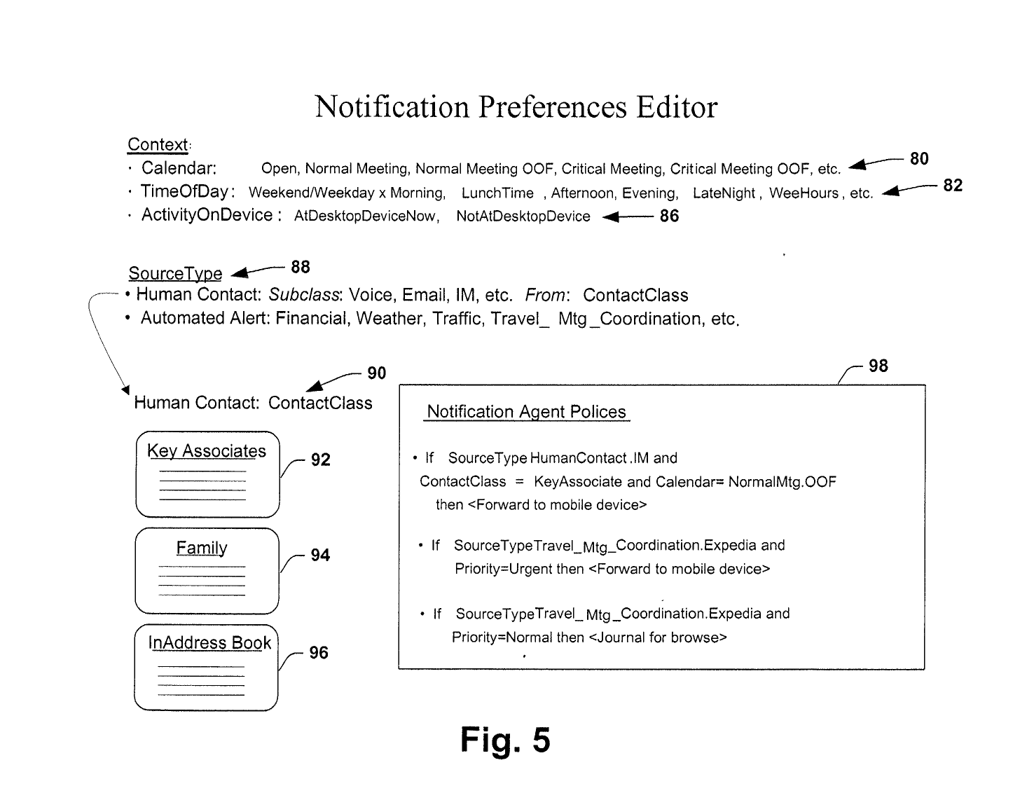

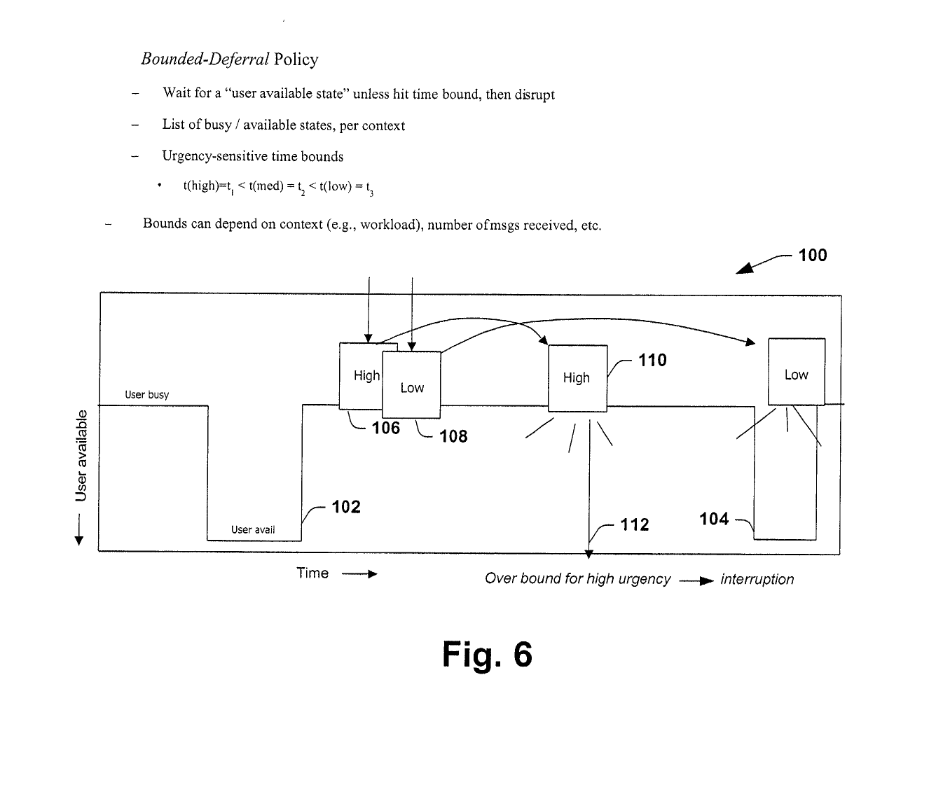

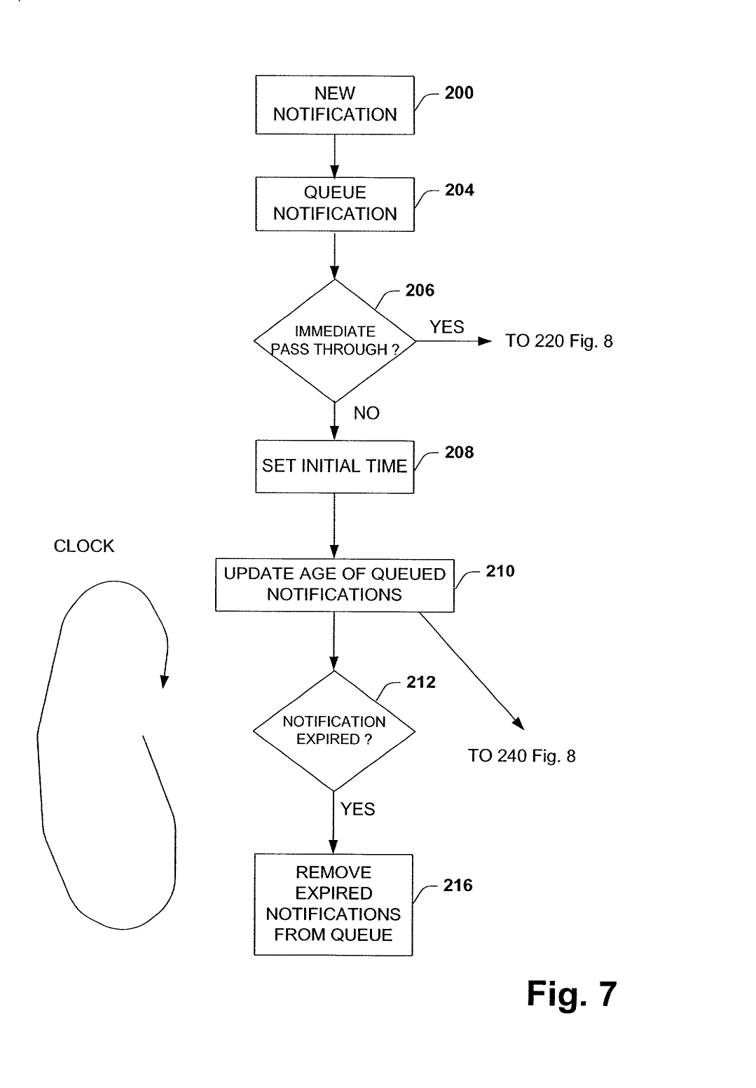

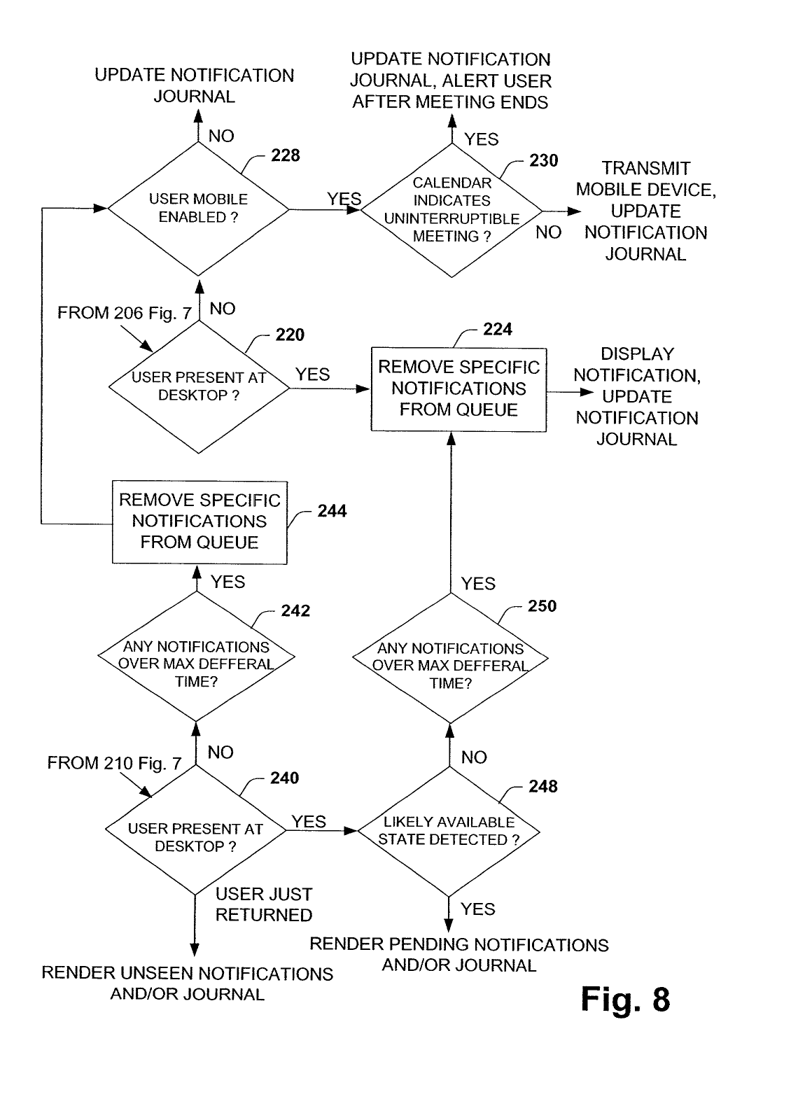

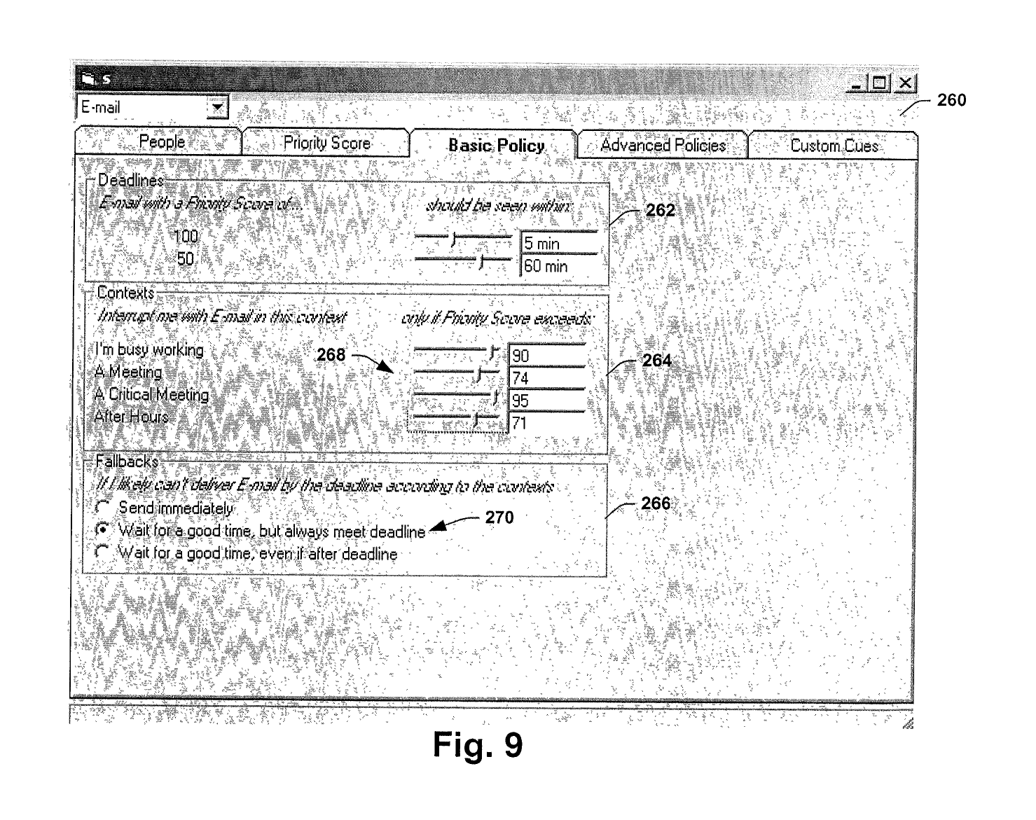

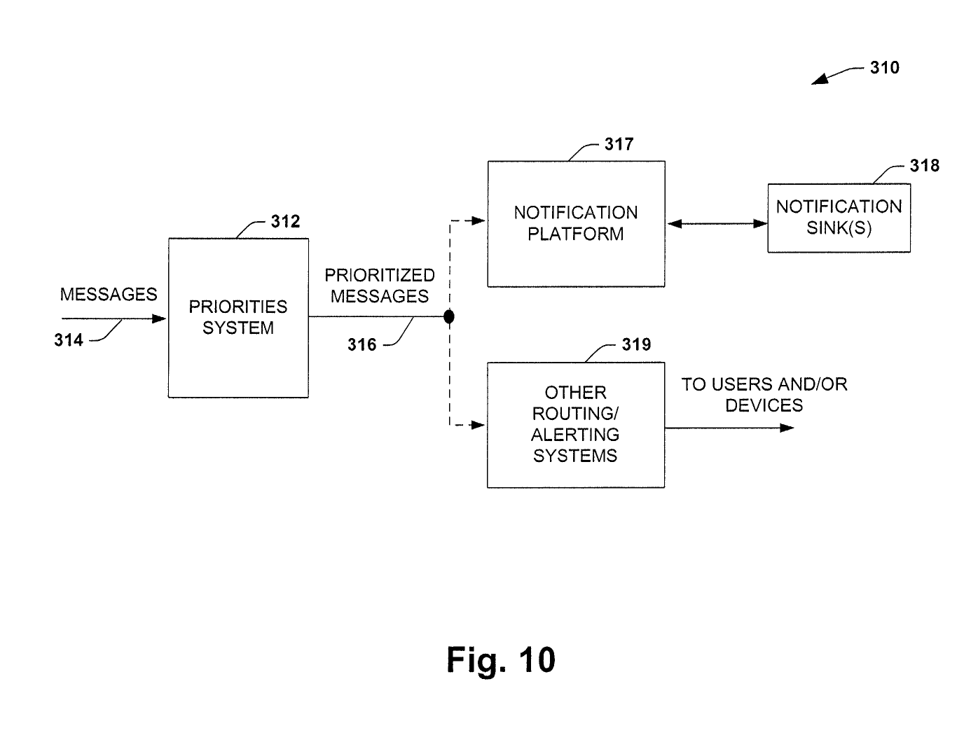

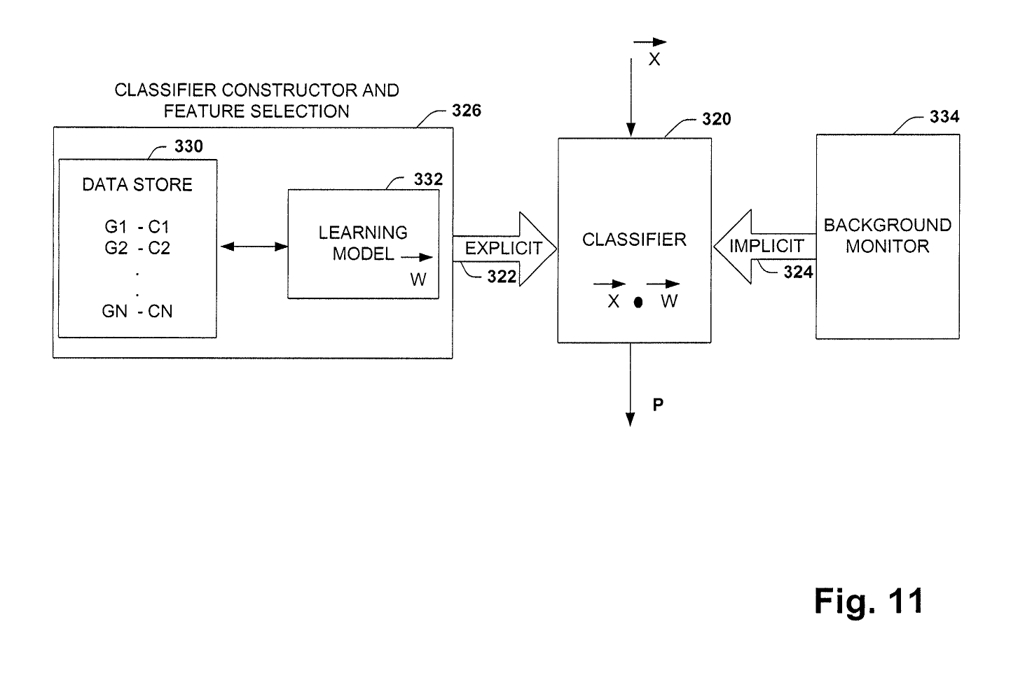

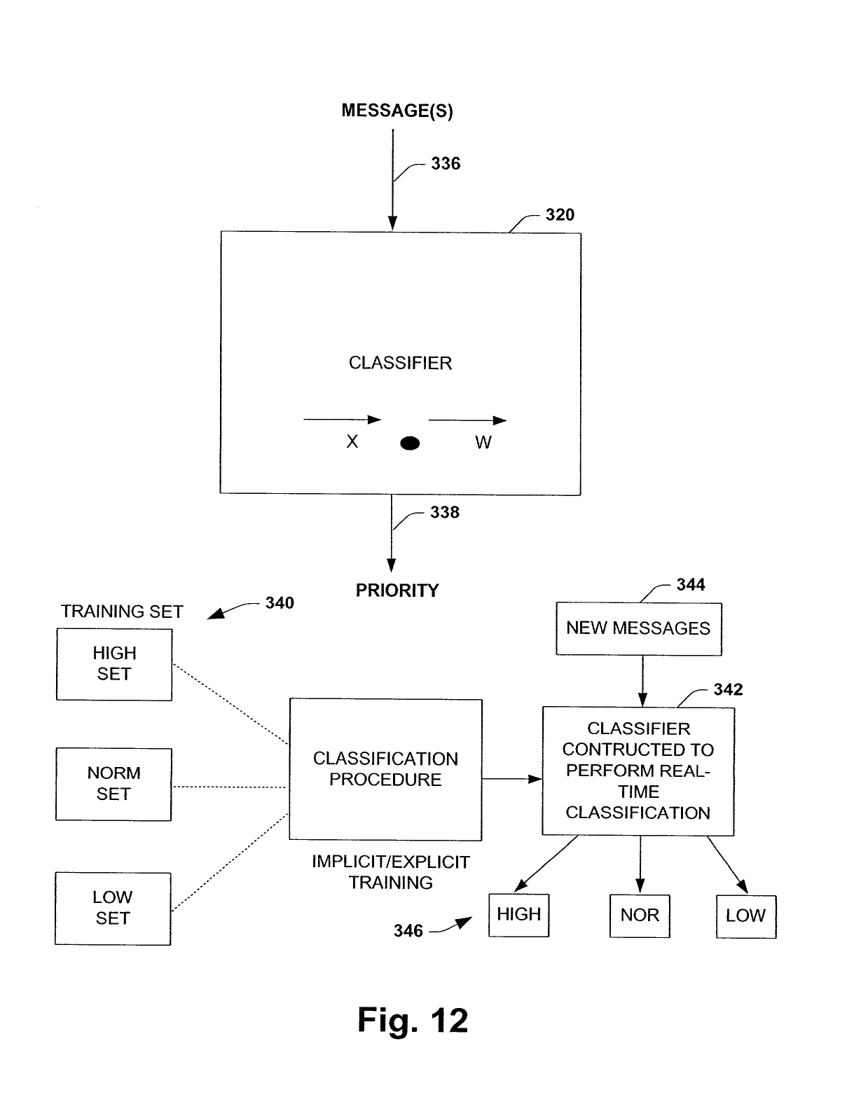

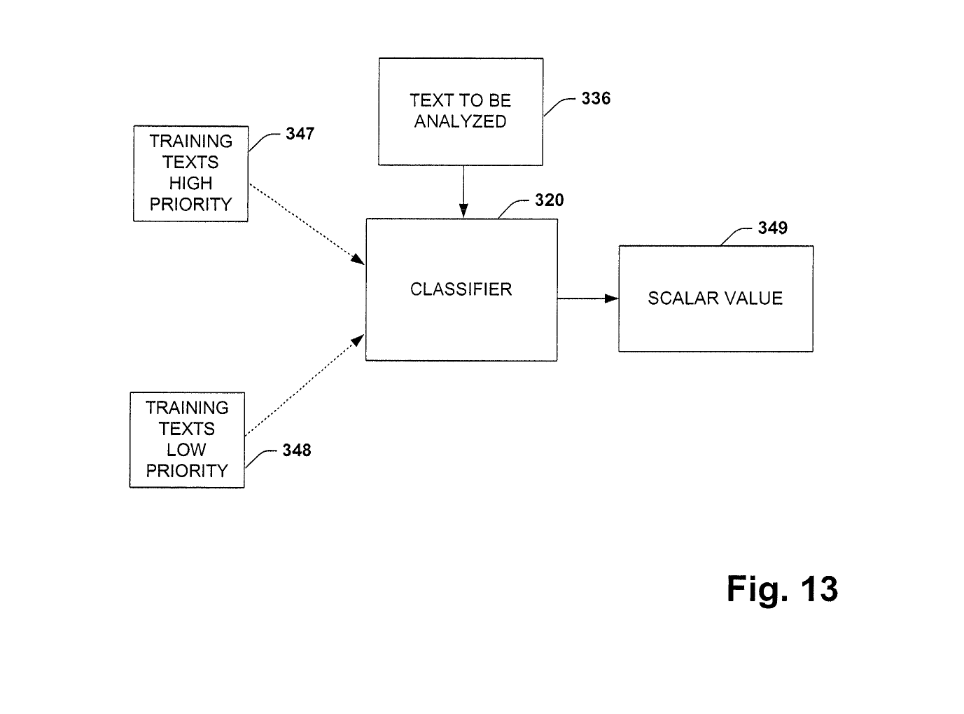

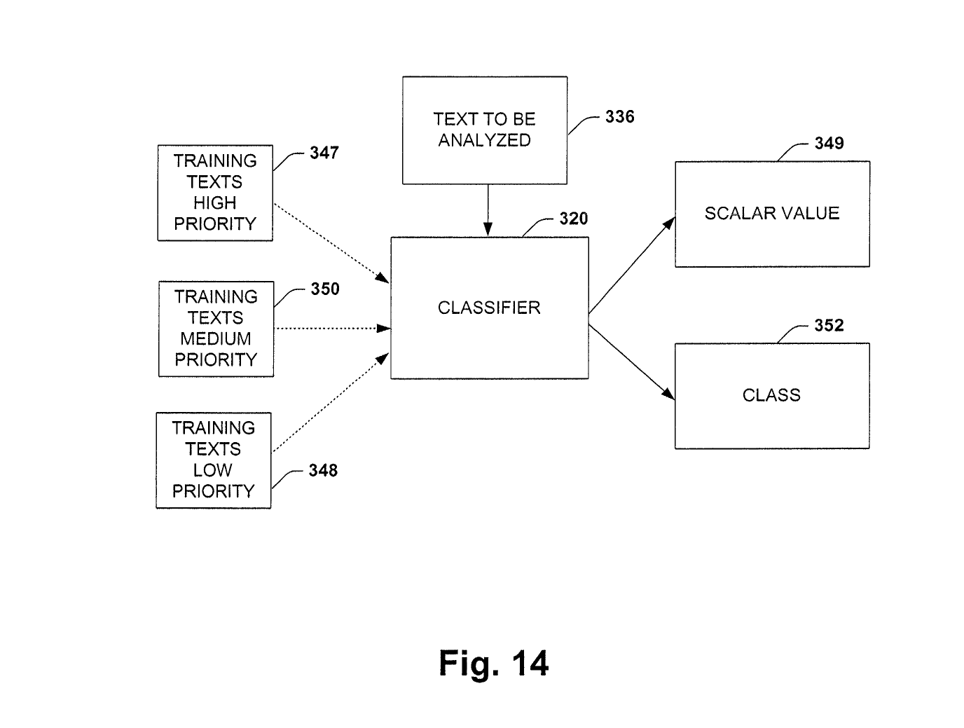

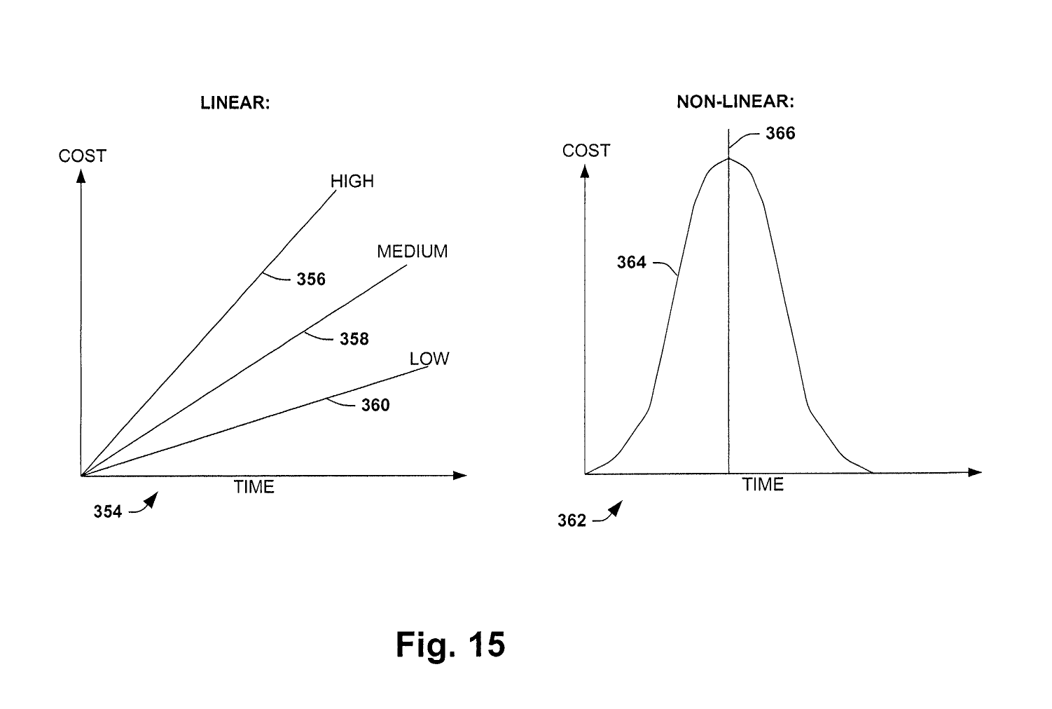

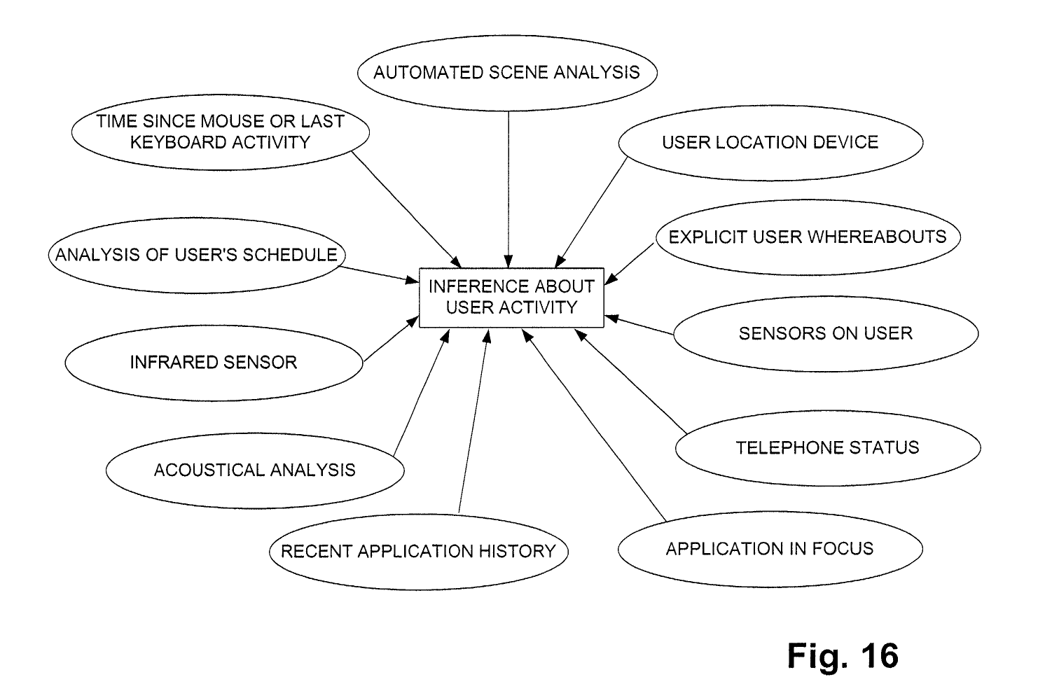

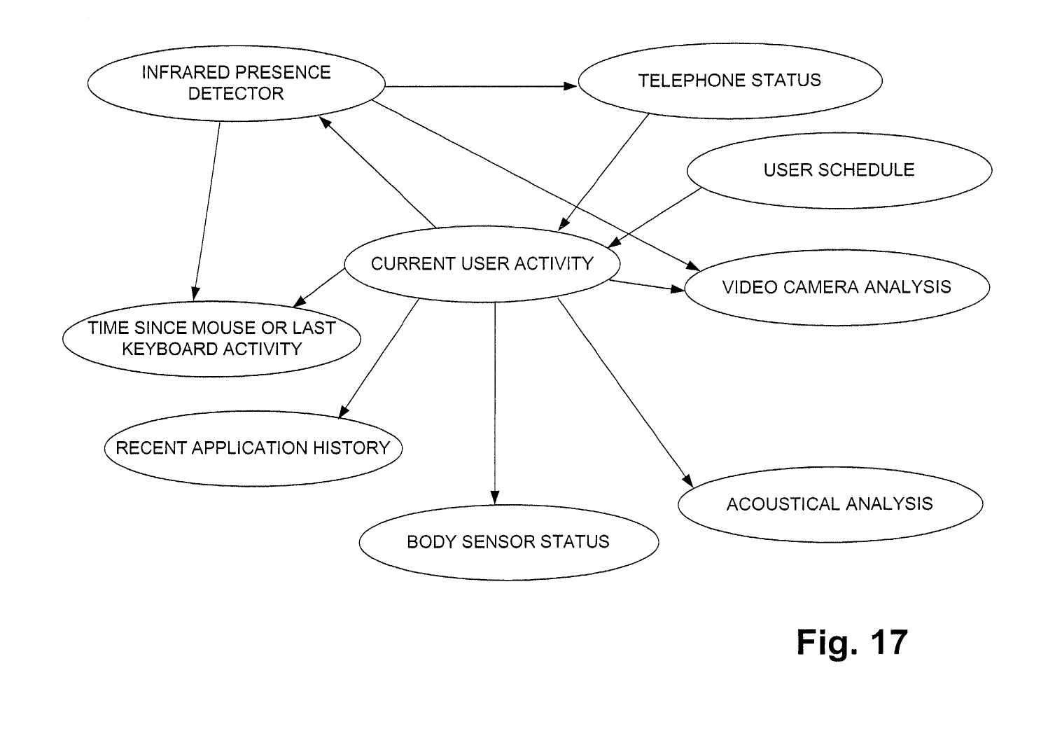

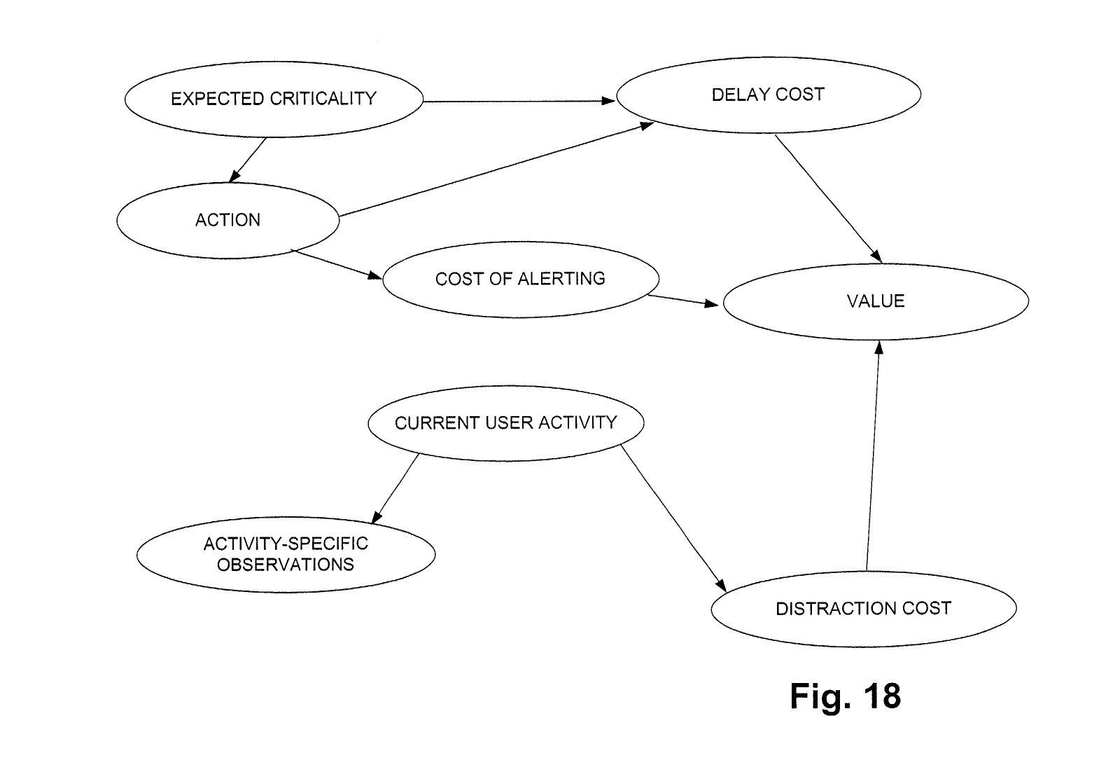

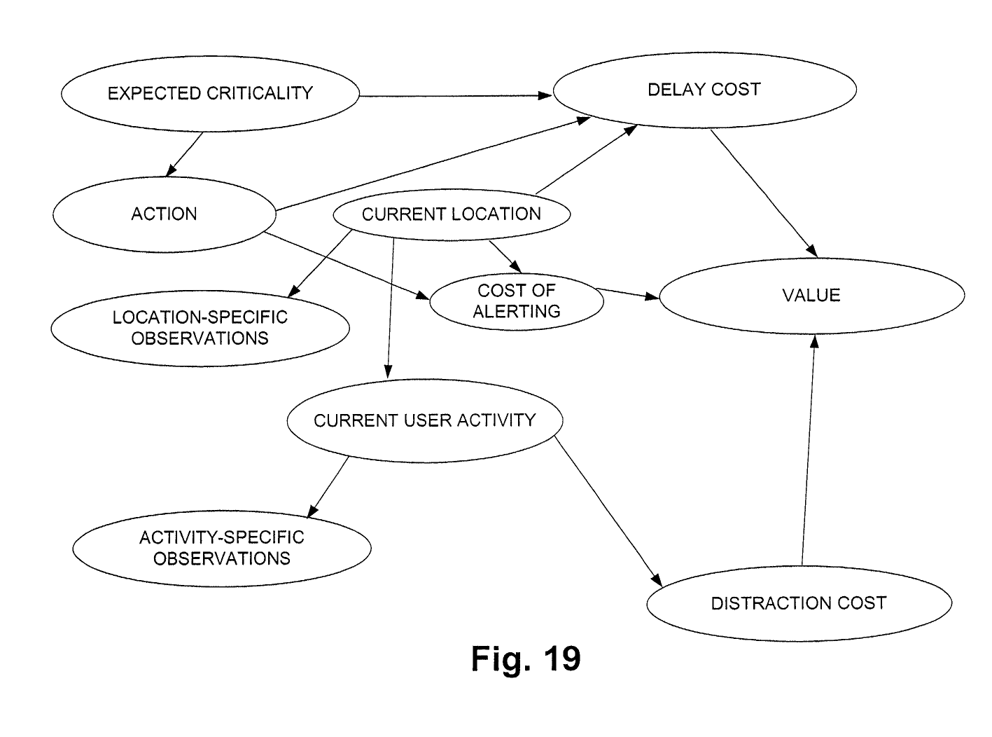

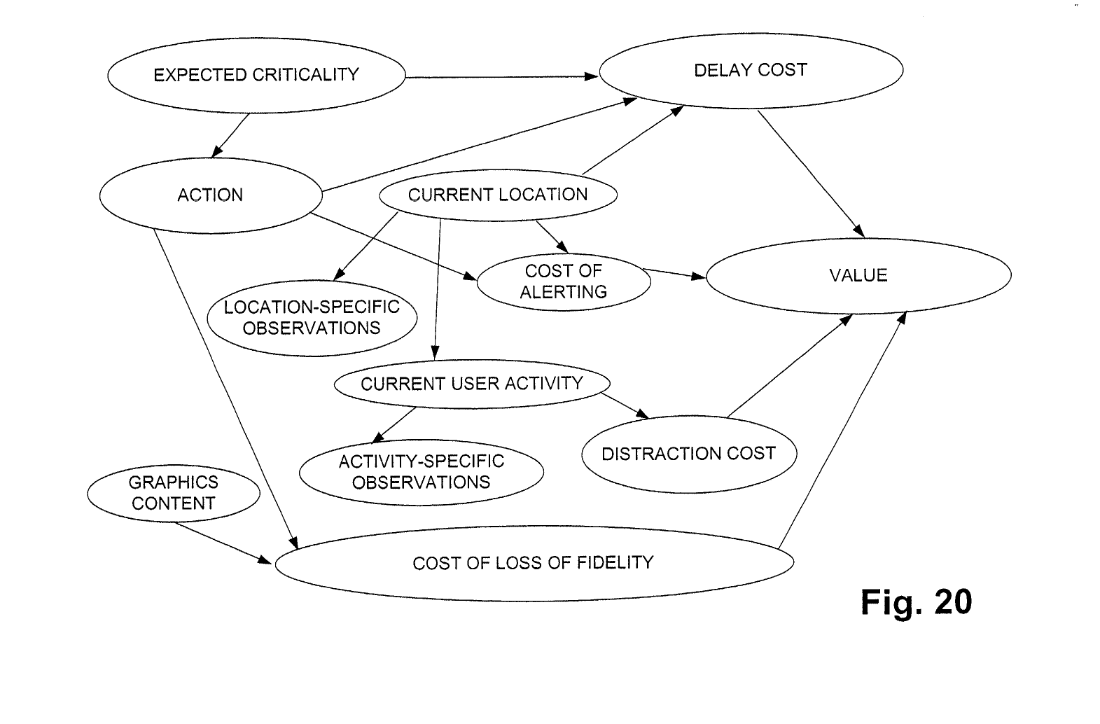

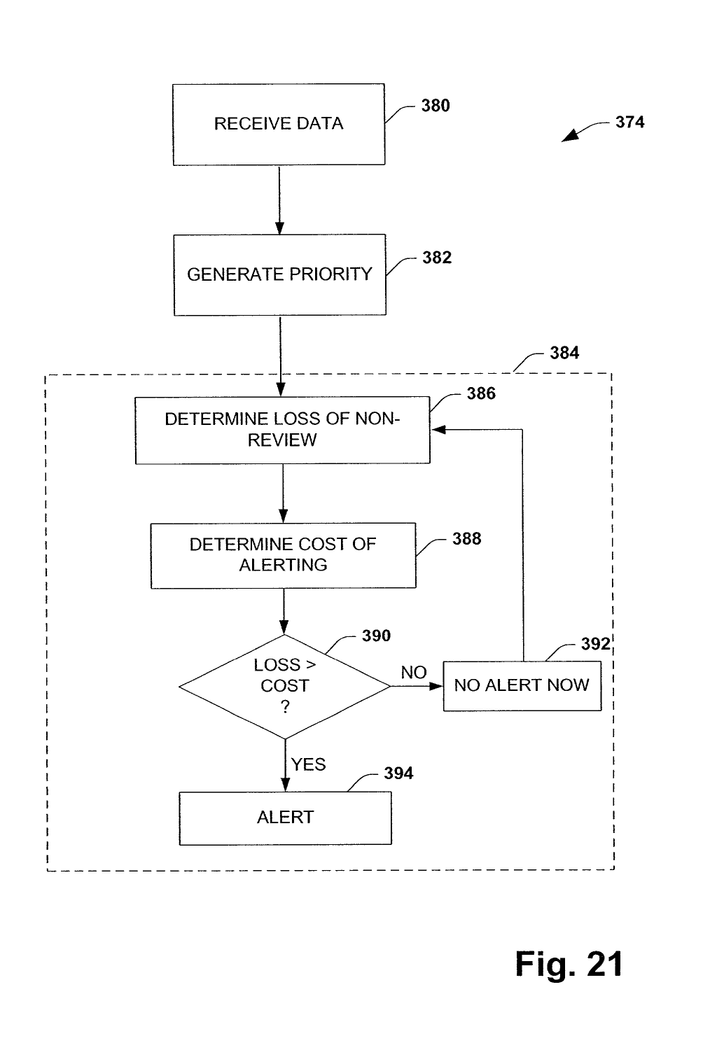

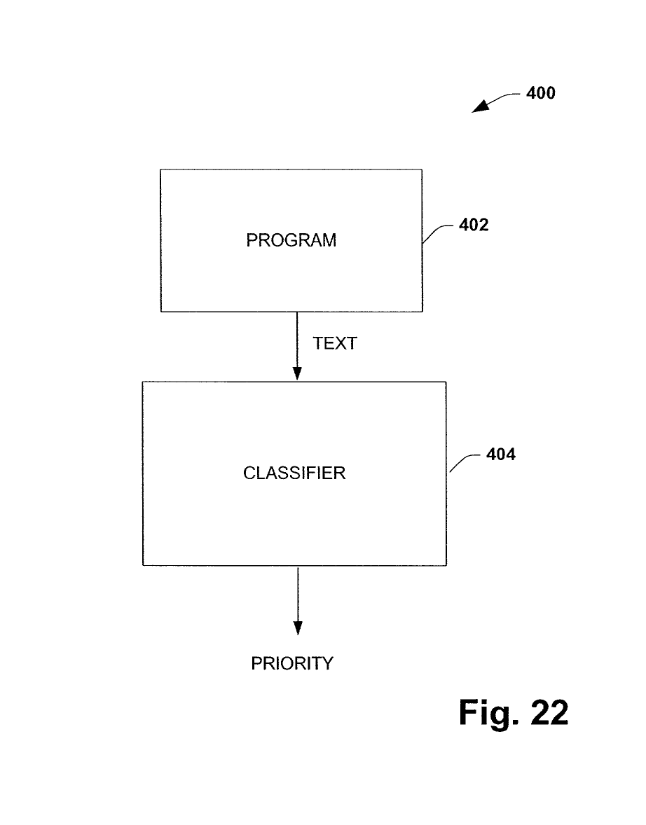

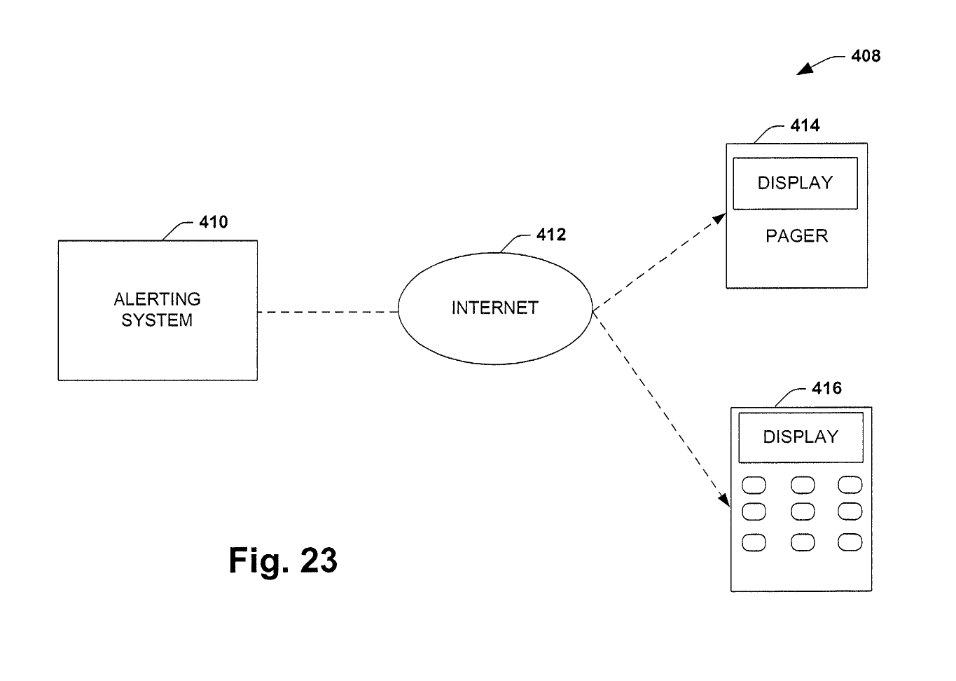

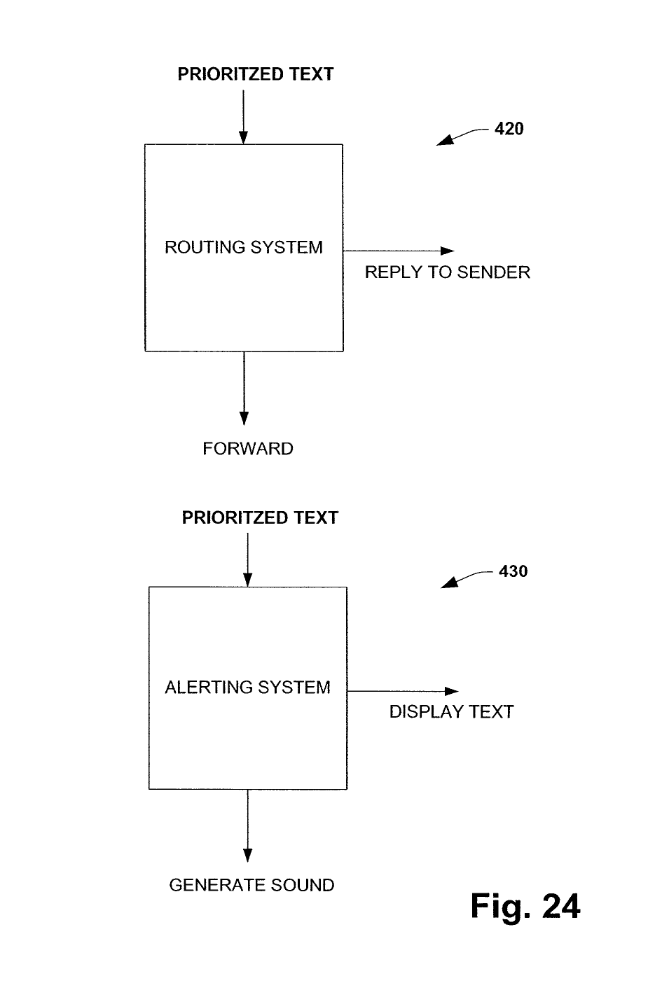

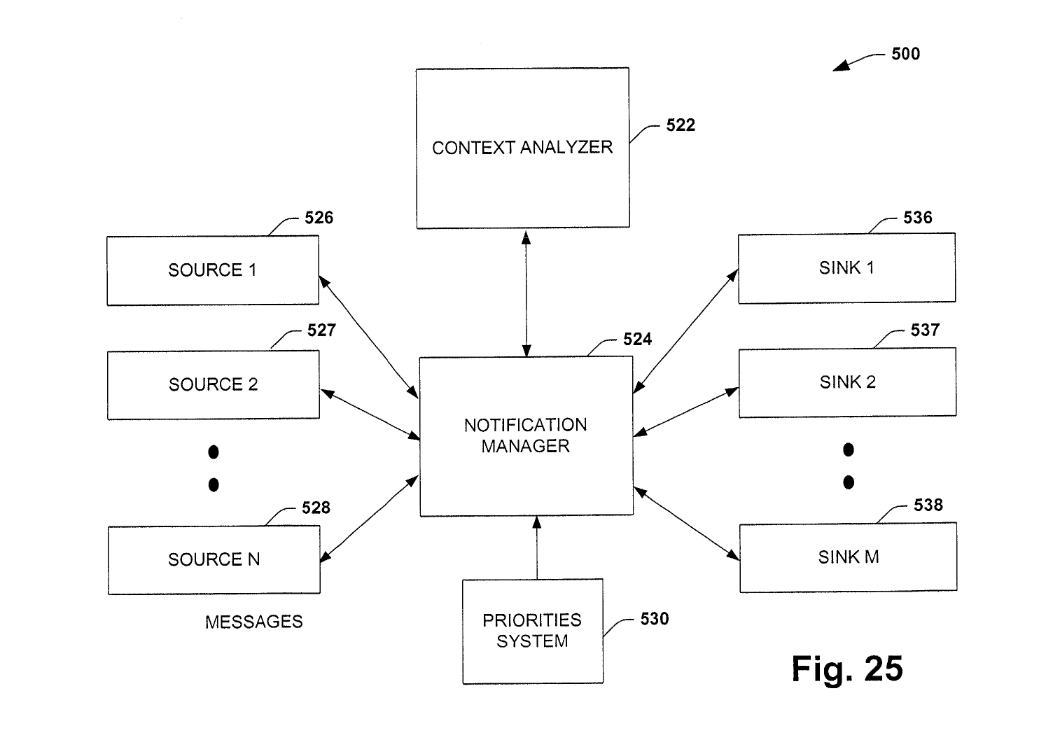

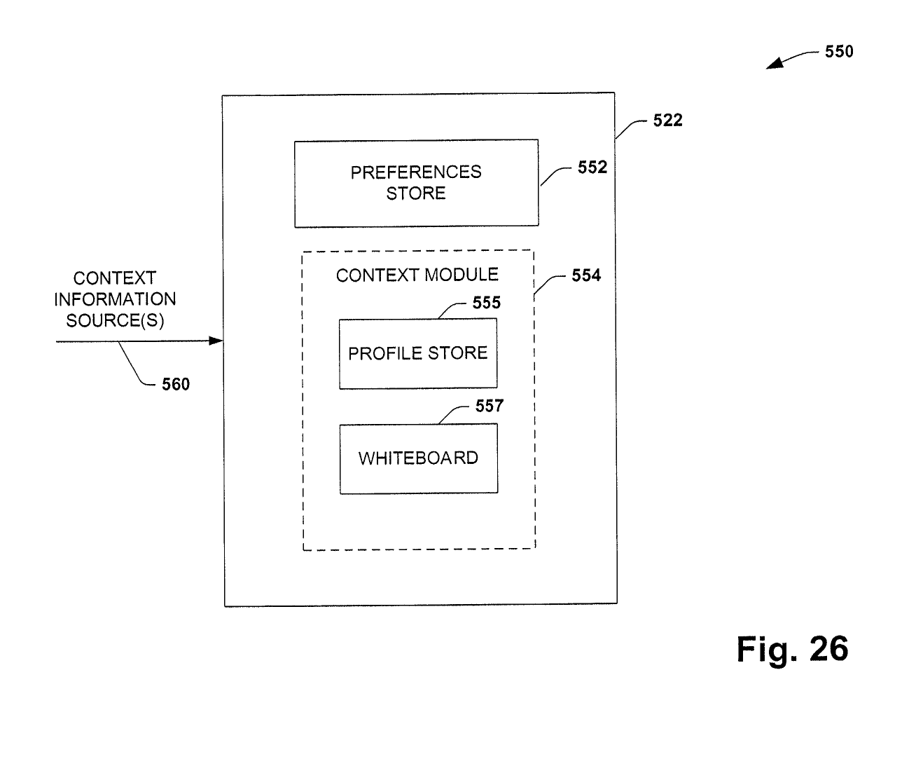

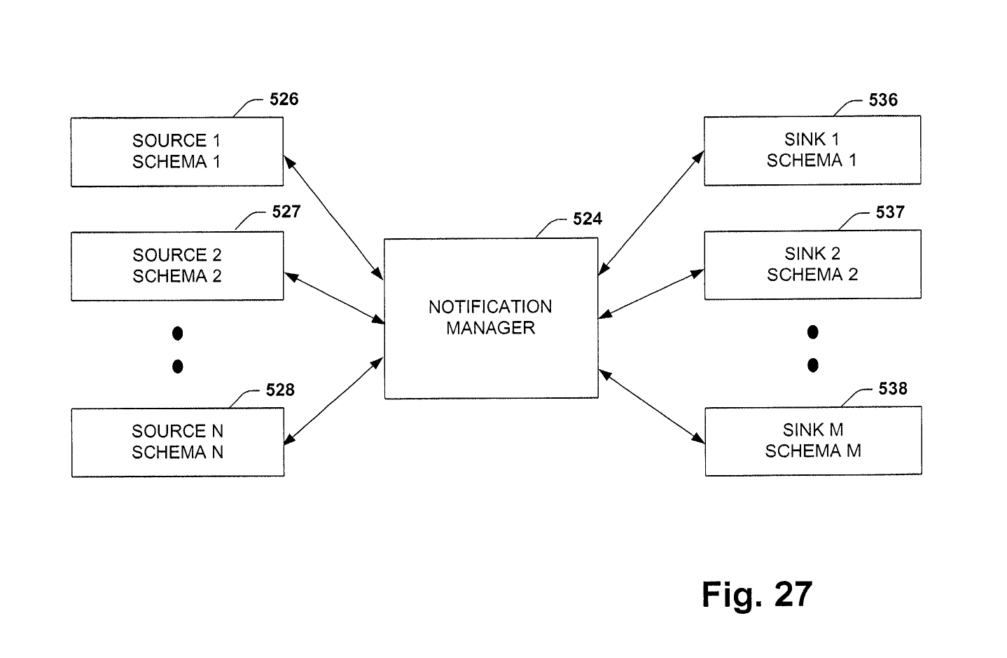

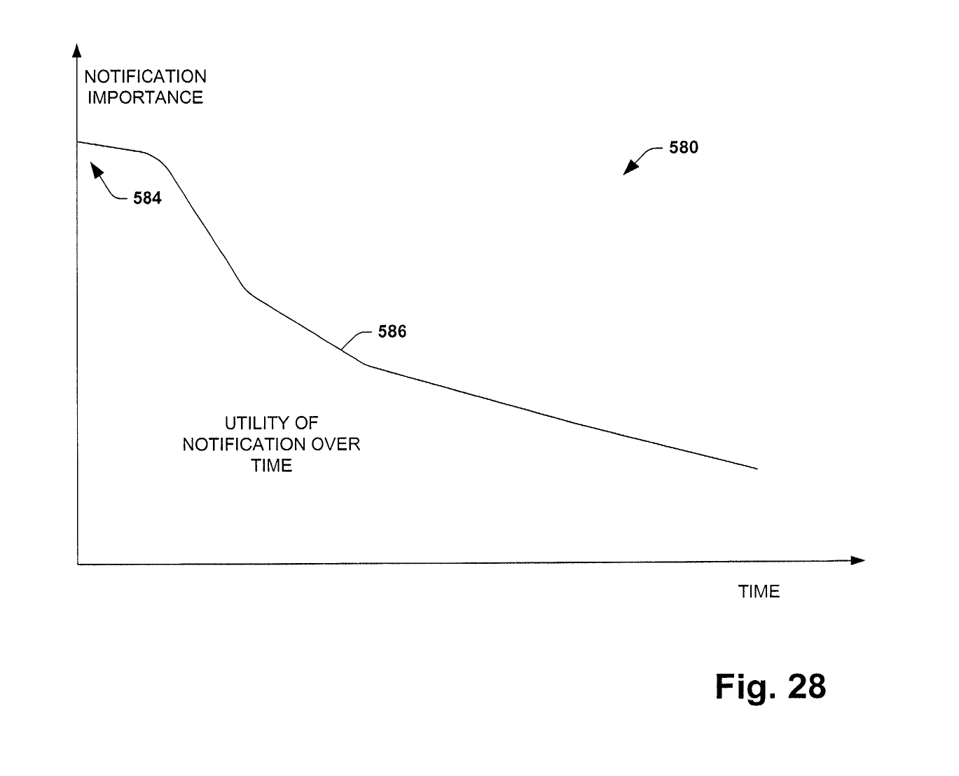

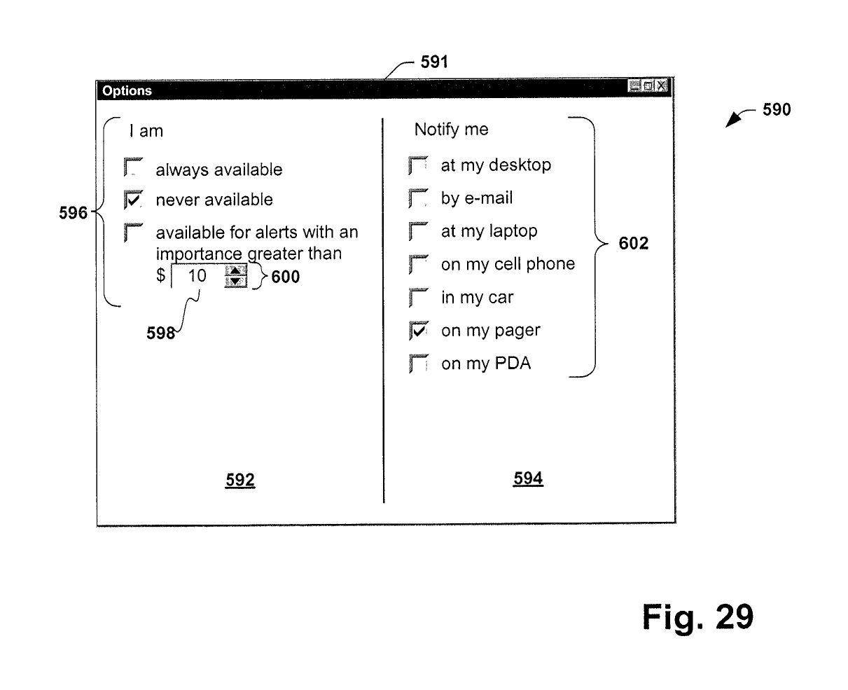

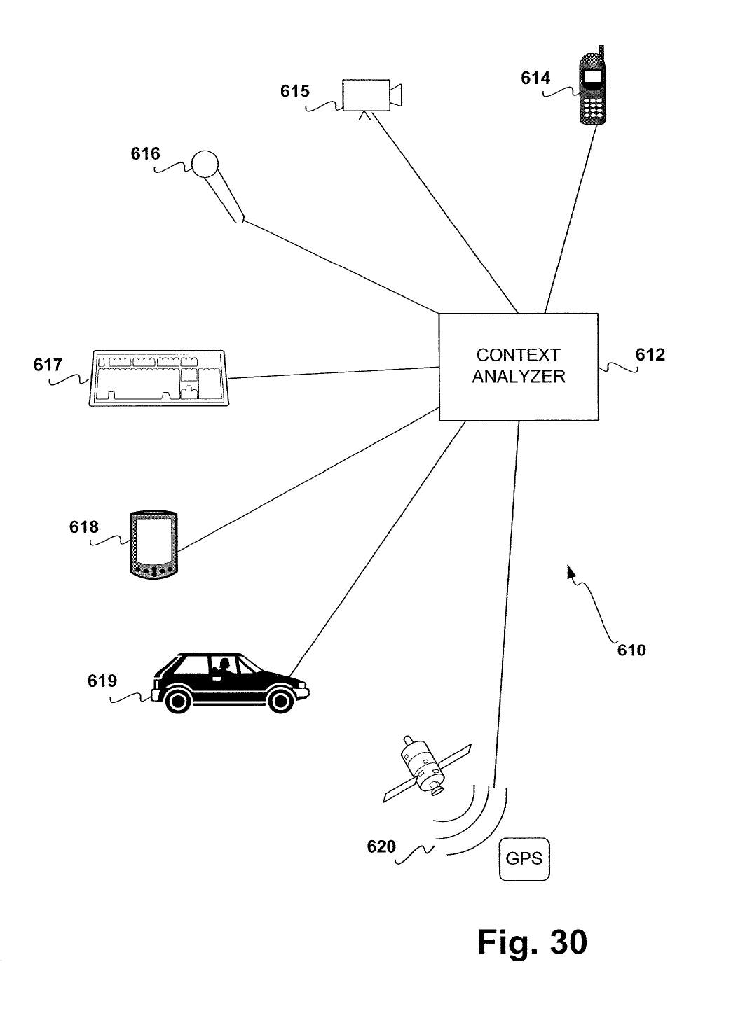

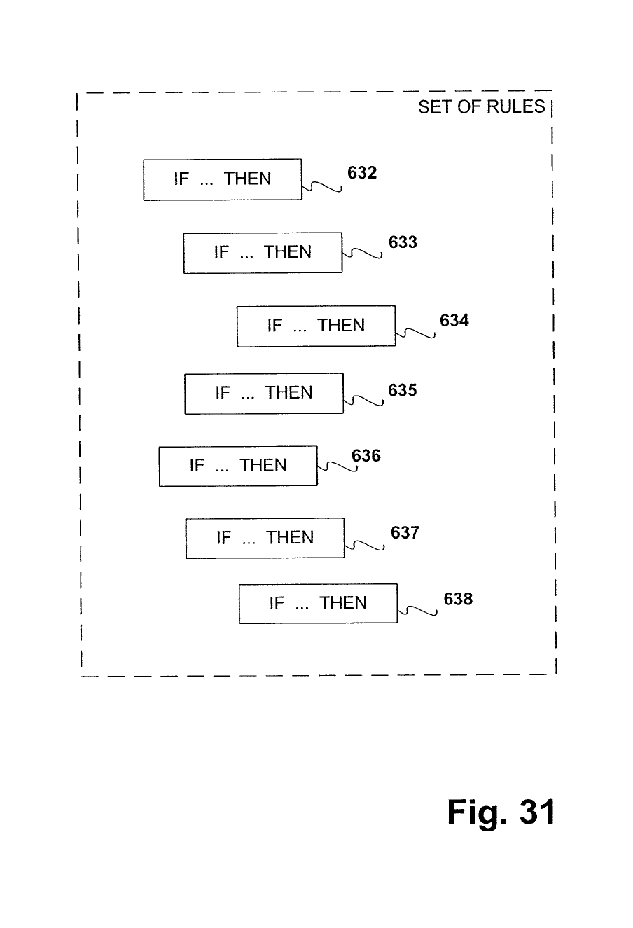

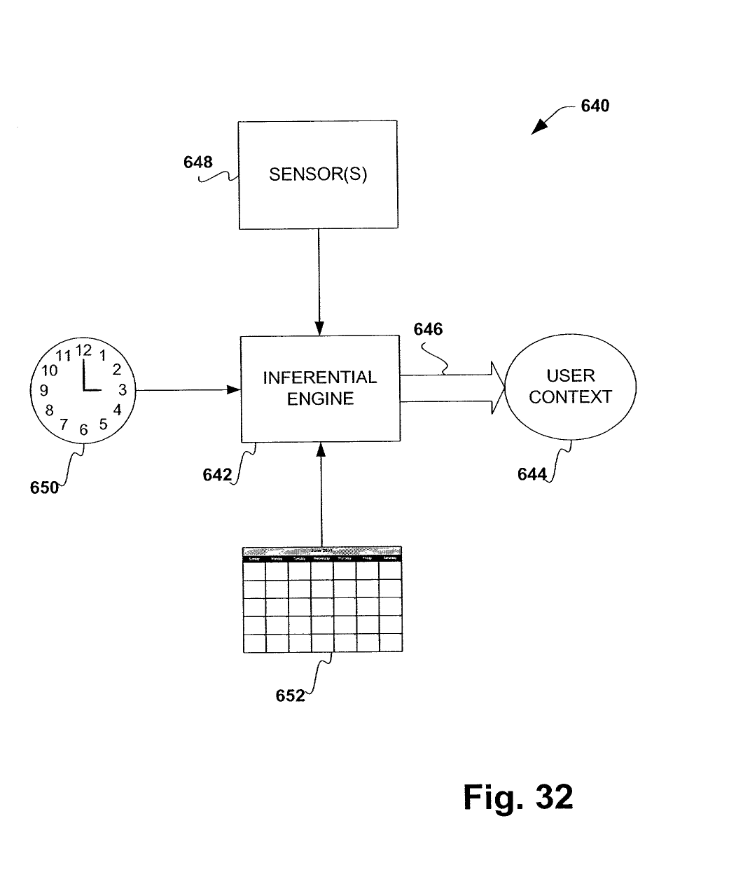

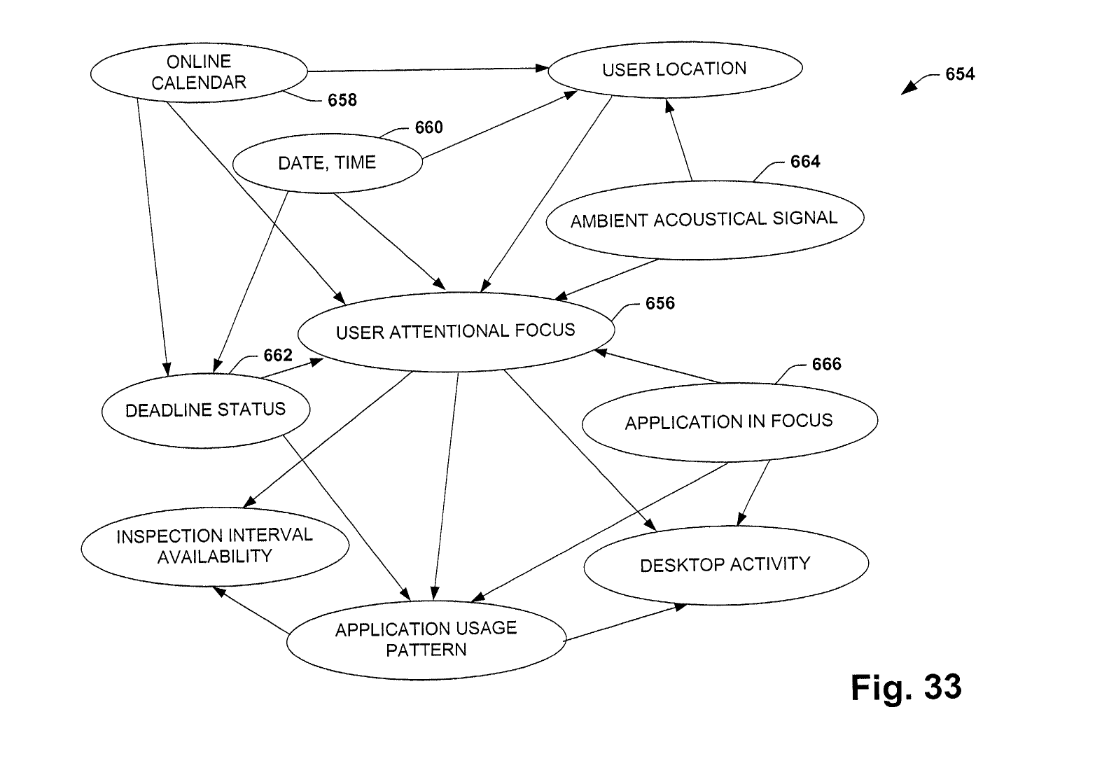

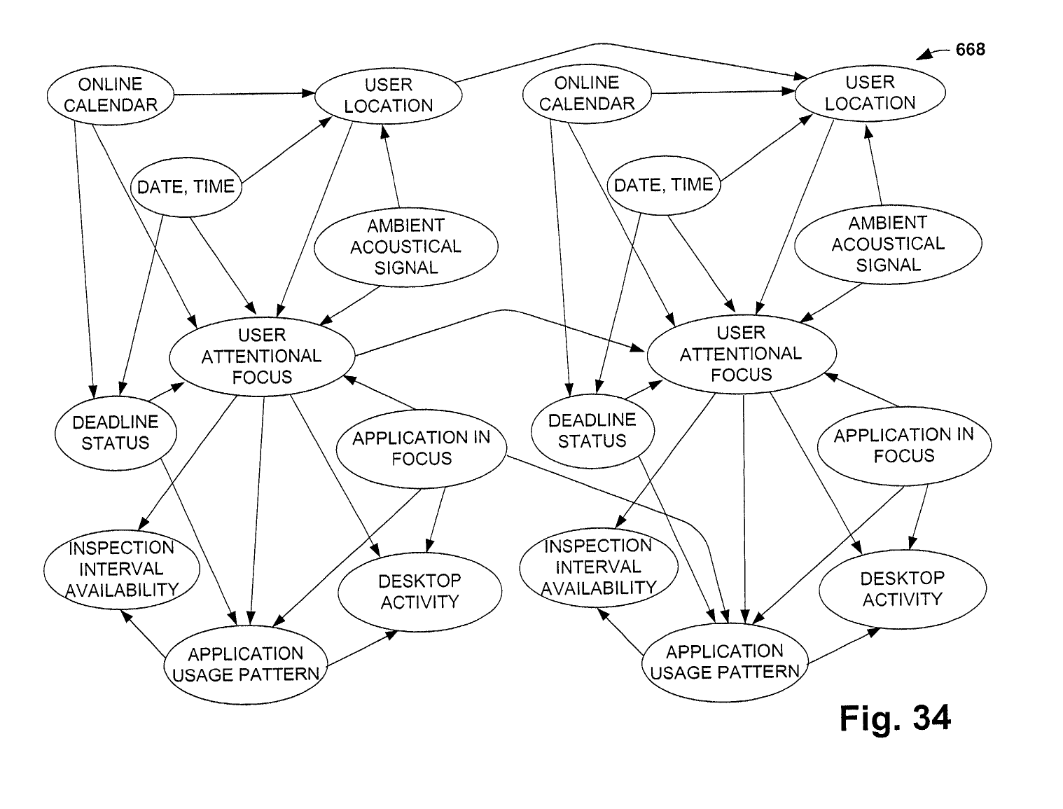

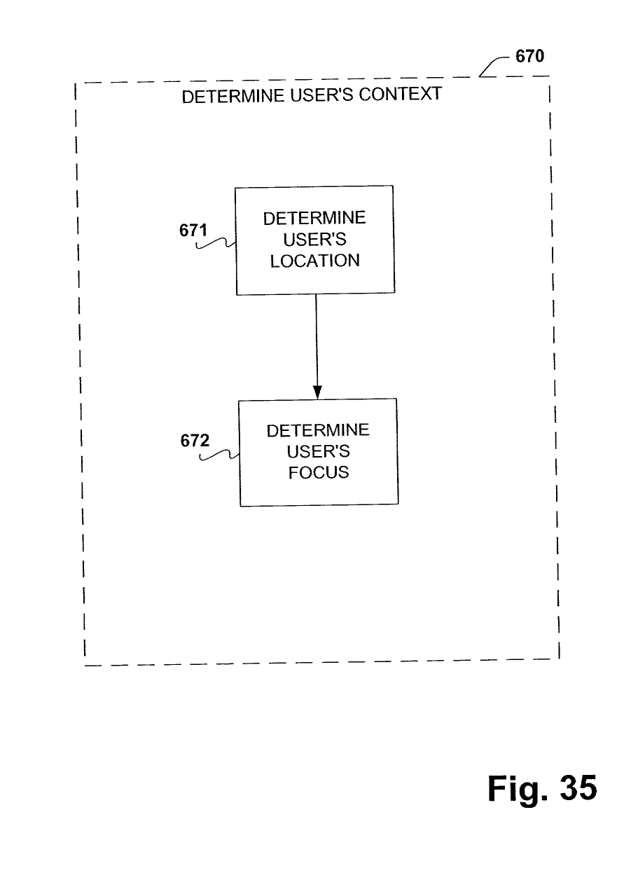

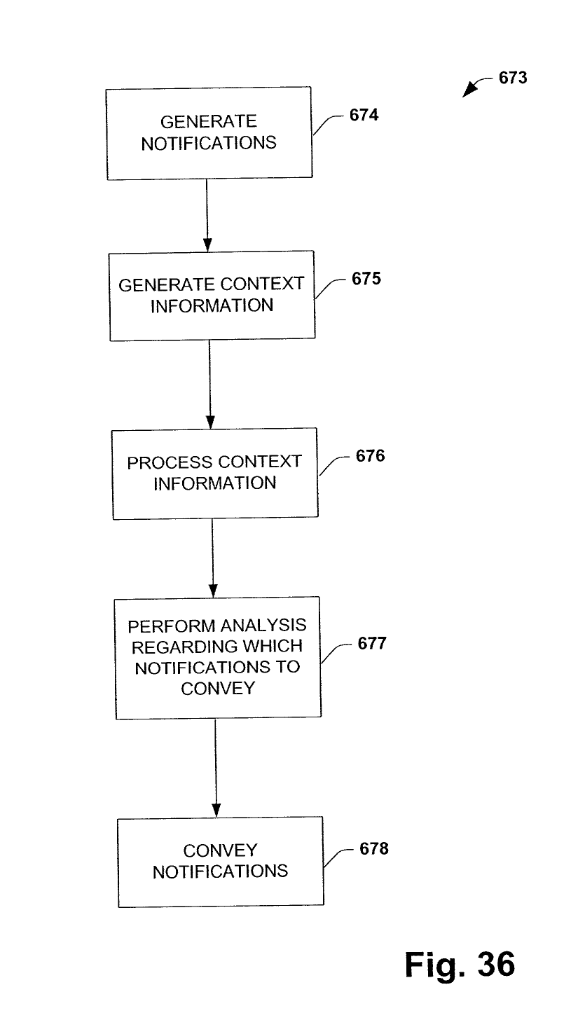

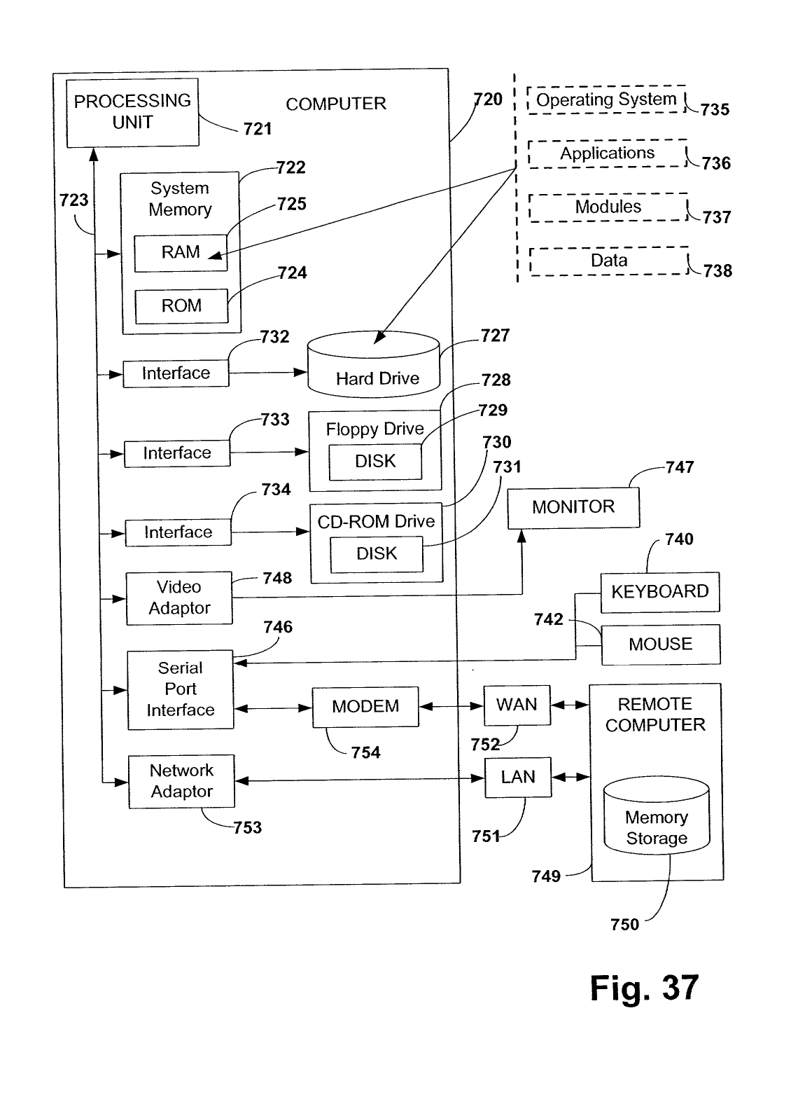

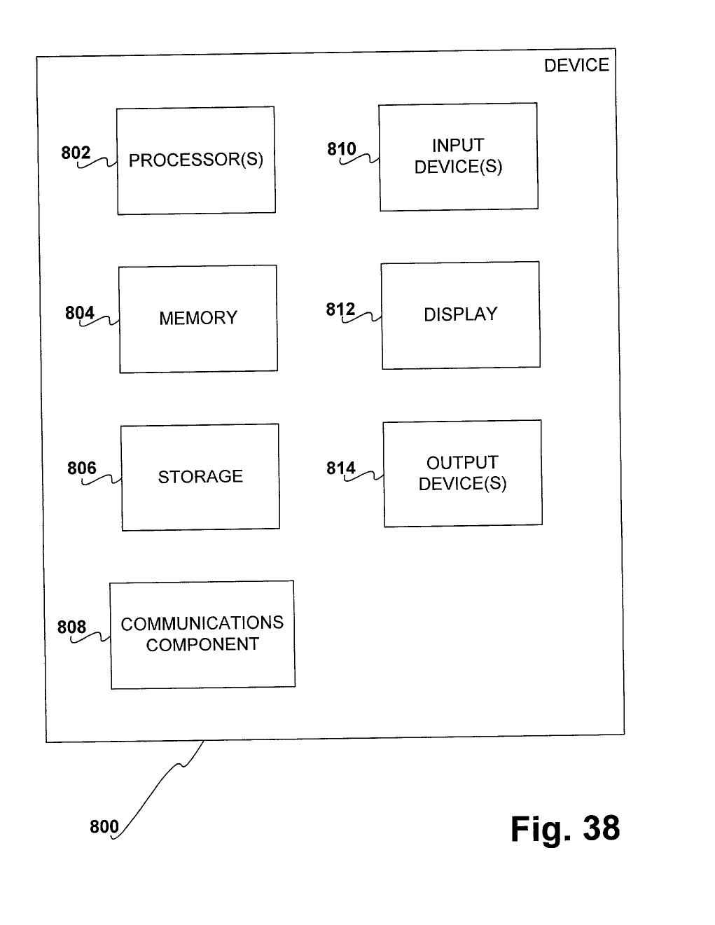

Turning now to FIGS. 3 and 4, a subscription service and process for tagging notifications at notification sources is illustrated in accordance with the present invention. FIG. 3 illustrates how notifications from various alert sources 60 can be tagged with an urgency, importance, and/or priority value in a local user profile 64 stored at the source. For example, a subscription file 66 can be configured with various designations set by the user. In the subscription file depicted in FIG. 3, a source 1 is depicted as checked for urgent priority, whereas a source 3 is depicted as normal priority. It is noted that a plurality of other designations of priority may be similarly configured (high, medium, low, important, not important, etc.) In reference to FIG. 4, an Expedia source 70 is illustrated, wherein a subscription file 72 manages changing situations and/or exigencies. As an example, a selection 74 is marked urgent if a flight arrival is changed by more than 20 minutes. Another notice regarding ticket fares is selected as normal at 76. It is to be appreciated that other rules and/or priorities can be similarly configured.

Referring now to FIG. 5, a notifications preferences editor is illustrated in accordance with the present invention. For example, this can include definitions relating to the users context such as a Calendar 80, Time of day 82, and Device Activity 84. The Calendar 80 designations can include, for example, open, normal meeting, normal meeting outside the office, critical meeting, critical meeting outside the office, as well as a plurality of other designations as can be appreciated. The Time of day 82 can include weekdays/weekends, morning, lunch time, afternoon, evening, late night, wee hours, etc. The device activity 84 can include at desktop now, not at desktop device, and at a designated mobile device, for example. Other settings can include source type information 88 such as human contact information that can include a subclass designation such as voice, e-mail, or other human contact sources. Additionally, this may include automated alert types such as financial, weather, traffic, travel, sports, and substantially any type of automated information source. As a further example, the human contacts can include a contact class 90 than can include entries for key associates 92, family 94, and an InAddress Book 96. It is noted that other contact classes can be similarly designated.

After the user has provided respective configurations described above, notification agent policies 98 can be configured that enable notifications having an associated schema that match the user configurations to provide notifications to the user. For example, if the received notification source type 88 were human and the contact class 90 was a key associate, and the Calendar was detected as a normal meeting, then the notification can be forwarded to a mobile device. As another example, if the source type 88 was travel, and the priority was urgent, then forward to a mobile device. Similarly, if the priority were normal, then the notification can be directed to a journal for browsing. It is noted that a plurality of other message forwarding policies and combinations thereof may be similarly configured.

Turning to FIG. 6, a timing diagram 100 illustrates a bounded deferral policy in accordance with the present invention. According to this aspect, notifications are not delivered until an available free state is reached unless a time bound is detected. For example, free states are illustrated at references 102 and 104. During busy states of the user (depicted as opposite to the free states 102, 104) a high and low priority message 106 and 108 are queued by a notification agent (not shown). At 110, a time bound that was set as a max deferral time described above is reached for the high priority message and thus the high priority message is delivered to the user at 112. The low priority message 108 does not reach a time bound in the illustrated example of FIG. 6. Thus, the low priority message is not delivered until the next available free state at 104. In this manner, disruptiveness of notifications received by the user are mitigated. It is noted, that the time bounds can be influenced by the users context such as workload, number of messages received, and the time dependency of the notification content as described above.

In accordance with the present invention, various algorithms and/or processes are provided for desktop and mobile alerting. These processes can be applied to multiple situations such as: (1) User present at desktop device; (2) User away from desktop device; and (3) User just returning or logging in to a desktop device after being away.

For the case where a user is detected to be at a desktop device, the following process can generally be applied:

1. When a notification is received, its age is set to zero and its priority is noted and a list of exceptions is checked.

2. If a “likely available” state is observed via monitoring the user's activities before the max deferral time for that urgency, the notification is passed through to the user.

3. Else, the notification is relayed when the max free state is reached for the notification as depicted above in relation to FIG. 6.

On average, because of the typical smatter of “likely available” states during typical desktop work activities, most notifications will tend to be delivered before the max deferral times. However, user's will be more pleased on average with the notification system as notifications will tend more so to occur when the user is free than they would have been had notifications simply been passed through when notifications are received. The probability that a free state will be reached generally increases with time—as there are more opportunities for detecting a likely available state with increasing amounts of time. As the probability of a likely free state increases with increasing amounts of times, lower priority messages will tend to occur with higher-likelihood during these likely free states, and the probability of being disrupted will grow with the increasing priority of the messages.

According to another aspect of the present invention, a display of notifications (e.g., journal, browser, in-box) can include multiple, or pooled notifications that have been waiting, so as to send to the user a single notification that contains chunks of grouped notifications. Such chunking can present the chunks of notifications in lists ordered by max priority, max age, or max priority by group, etc. For example, if a likely free state has not been detected, and that max deferral time has been reached by a high priority notification, and at the time the max deferral has been reached for the high priority notification, information can be included about the lower priority notifications that are pending in a grouped notification—even though the lower priority notifications will not have obtained an associated max deferral at this time. Several aspects are possible for this kind of chunking, including sending the main alert in a standard notification display, and summarizing other pending alerts in a list at the bottom of the display. Respective items can be clicked on and be reviewed and/or cleared by the user.

According to another aspect of the present invention, the calendar can be examined to enable users to specify uninterruptible meetings (e.g., presentations) that should not be interrupted (e.g., until some safe time, 10 minutes after end of meeting) except for notifications that are marked as immediate pass through. This can be generalized to utilizing a separate max deferral table and/or function for important meetings. This can be further generalized by enabling calendar items to be one of several classes of appointment and employ different max deferral tables or functions for different classes of meeting.

In another aspect of the present invention, instead of providing a few categories of priority, a continuous range can be provided, such as, 0-100 for an urgency score and the max deferral can be a function of the priority of the notification, including a variety of linear and nonlinear functions (e.g., exponential decay of max deferral time with increasing priority). For example:

max deferral(priority)=e^{-k(priority)}×15 minutes

which is equivalent to

max deferral(priority)=e^{-k(priority)}×max deferral(0 priority)

Additionally, users can specify contexts as a function of type of day (e.g., weekend, holiday, weekday), time of day, and other basic contexts that change value assignments for different classes and subclasses of message (e.g., e-mail, Messenger communications from family versus business associates).

In another respect, a Notification Journal for items that have not yet been observed by the user can be provided. This can include maintaining a global Notification Journal for substantially all notifications—enabling users to return and access notifications that have been previously received, for example. This can also include providing for rich display and interaction. For example, a click on a journaled item in a Notification Window can bring up the notification. A click on the notification brings up more information or the appropriate UI for the source of the notification. For example, clicking on a notification about an upcoming appointment brings up a full view of an appointment being referred to by the notification. Also, highlighted links can be displayed within notifications and enable users to jump to web pages, applications, or information associated with the notification. Furthermore, advertisements, special backgrounds and/or other branding information (from the source) can be displayed in the notification window, when a notification is rendered.

In another aspect, notifications with active durations, and/or with expiration dates, can be removed from an active queue after the date has passed. Notifications in a journal can be listed as expired if users are interested in seeing the history of this kind of activity. In addition, classes of notification can be tagged as being intrinsically replaceable by any update of information as identified by a Globally Unique Identifier (GUID), for example, in order to provide an update on the world state of information that the notification is reporting.

User Interface tools can be provided that enables users to append priority information to messages, or, more simply to do a normal Send or a When Free send. A When Free send would be ported through the bounded deferral system described above; a normal send can act as a non-bounded communication. Notifications can also be tagged with application-specific (or life-specific) contexts from a set of contexts (e.g., MS Word at focus, MS Outlook at focus, etc.) and render the notifications within the active context if it has not expired. For example, an assistance tip about a word processor usage rendered via a notification system should generally be provided when the word processor is at focus. If the application is not at focus, the tip should simply be journaled.

More advanced features can also be provided. For example, a frequency of “likely available times” for a user can be observed and learned, when users are working at a desktop, and the frequency with which alerts are received by the user in each class, and infer the expected time until the next likely free state, from a user's activity (based on application, time of day, expected user location, etc.). This information can be employed to automatically set the max deferral times for a respective notification priority class so as to enable the notification system to bound the probability of being disturbed for each priority class of alerts. This can be set by default, or can enable users to specify a probability for each priority class, and thus, inform the system that they do not want to be disturbed (that is, alerted when busy) for more than say, 5% of the time for low priority alerts and more than 10% of the time normal priority alerts, and 25% of the time for high priority alerts, etc. That is, users can specify a target “tolerated probability” of disruption for a respective priority class and the system can set the max deferral times for the classes.

Confirmation can be received that important notifications have been observed, for example, a convention can be employed that hovering over a notification is a signal that “I got it,” and utilize this feedback as an option that a user can turn in via a profile. That is, users can opt to turn on the option:

[ ]Continue to notify me about critical information every [x] minutes until I confirm with a mouse over.

When a user has been away from a desktop device for more than x minutes (set as default or by user specified amount of time), desktop events can be deferred, and instead notifications can be sent to a mobile device. Similar max deferral times can be employed as specified for desktop alerting, or instead access an alternate set of max deferral times for the “away” condition. That is, another table or function for controlling the max deferral time for the away situation can be employed.

Similar to the desktop situation, the user's calendar can be accessed for uninterruptible meetings, such as presentations, or other meetings that should not be interrupted except for notifications that are marked as immediate pass through. Similar generalizations per the calendar as described above in the desktop setting can be employed, such as utilizing information a respective manner that is provided in desktop settings or have special generalizations for the mobile settings.

In another aspect, set time of day constraints can be provided to restrict notifications during certain times (e.g., late at night and early morning, weekends). Users can specify classes of alerts they will receive to certain times. For example, all business related email and stock information will not be sent to a mobile device on weekends.

Messages sent to a cell phone or pager can be journaled by a notification manager and available when the user returns to the desktop in a notification journal view—or accesses a journal view on mobile device. Similar chunking of alerts can be employed for the mobile setting as for the desktop, described above.

Mobile devices such as embedded auto personal computers (AutoPCs) and appropriately instrumented hand-held personal computers (HPCs) (i.e., that have accelerometers) can be employed with the present invention. For these devices, presence information is used to infer they are active based on touch and/or acceleration, for example. A list of likely free states is created for some significant and/or distinct mobile settings (e.g., a set of states each for the case of driving and for walking). For example, for driving, free states can include “just stopped at a red light or other stop and there's no conversation,” or “cruising at a relatively constant velocity,” for example. Other systems can also consider different levels of attention (e.g., considering speed, complexity of breaking, steering, etc.) For HPC's, it can be inferred (e.g., Bayesian inference) with accelerometers that a user is in a car, and infer similar distinctions without direct feeds from an onboard automobile computer. For HPC's, it can be detected when devices have just been picked up, when walking or running has just ceased, or conversation has ceased, or when the unit has just been placed down to rest. For such mobile devices, notifications can be cached locally and rendered per likely free states. If are no detectable two-way connections, such information can be provided in a journal such as a desktop Notification Journal as having been sent to the mobile device.

Users can configure the notification system so that when a user first returns to a desktop (or laptop device) after an “away state” has been detected, a single notification can be relayed, the mobile notification journal, and enable users to select particular items to view the notification that would have been observed if the user had been at the desktop. For example, users may not have a mobile device, or not have the mobile device in service, or desire to simply specify that the notification system to work in a “desktop only” modality. In this case, the following can be performed:

When the notification system notes that a user has transitioned from a “user away” to a “user present at desktop device,” users are presented with a notification journal for all notifications that have gone over the max deferral time while they were away—or, per a user's preferences, foregoing the max deferral time and post all alerts to such a journal (e.g., sorted in a variety of ways per user preferences, by message class, by priority, or by date, or such combinations as message class containing the highest urgency alert, sorted within class by priority or by time, etc.). When the user is detected to be away, notifications can additionally continue to post on the desktop (e.g., in a pre-assigned area) a notification journal and continue to populate the journal (and sort by priority or by time of notification) with notifications that have gone over their max deferral time—or, alternatively foregoing the max deferral time and post substantially all alerts to such a journal. When such a journal is present, the user can be alerted with an audio cue—upon return or log in—that a journal is waiting for them. The display suppressed and rendered as an audio cue upon return and have the user take action to bring up the journal. In settings where users have been utilizing a mobile device, a journal can automatically remove journal items from the desktop journal when they are sent to the mobile device, or mark the notifications as having been transmitted to the mobile device, in order that users can sort and/or quickly scan for items they have not yet observed. Rather than posting a journal, a decision can be made to display a notification journal, chunked alerts (per the chunking policy mentioned above), or a single alert, depending on the quantity of journaled items.

Additionally, users can be enabled to specify that the notification system delay such a “display upon return” policy, and allow users to get to work when they return (to avoid the frustration with being hit by alerts when they wish to return and get something done), and/or wait for the next “likely free” state to appear. A special “pass through” can be provided for notifications immune to such suppression. For such a functionality, additional “likely free” state to be can be defined as: “user away and returns and does not begin active work with an application or with the system.” That is, it can be detected if users, upon returning to their desktop, begin work right away, and instead, wait until a “likely available” state is reached. If the user returns and does not begin work, this new likely free state is noted and thus causing a display of the notifications that are pending. If the user returns and is busy, the system can display notifications that have exceeded their max deferral, or, per user preference, display nothing until the next “likely free” state appears. At this time, the journal, chunked alerts, or single alerts are displayed to the user, depending on the quantity of journaled items.

Users employing a mobile device may have the device turned off or be in a region without service. Turning on the cell phone may eventually work in a similar manner as returning to a desktop. That is, a journal view of unseen alerts may appear and users can browse and bring up respective alerts. Other aspects of the present invention can enable desktop journals to be updated when messages are reviewed on a mobile device, for example.

FIGS. 7 and 8 illustrate methodologies for providing bounded deferral notifications in accordance the present invention. While, for purposes of simplicity of explanation, the methodologies are shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram.

Moreover, not all illustrated acts may be required to implement a methodology in accordance with the present invention.

Referring initially to FIG. 7, a new notification is received at 200. At 204 the received notification is placed onto a message queue. At 206, a determination is made as to whether the received notification should be immediately passed through to the user. This can be achieved by observing a setting such as a flag indicating whether the notification should be passed through. If the notification should be passed through, the process proceeds to 220 depicted in FIG. 8. If the notification should not be passed through, the process proceeds to 208. At 208, an initial time is associated with the notification such as a max deferral time described above. It is noted that acts 210, 212 and 216 can be executed as part of a clocked service routine or as an interrupt event, wherein these acts are periodically executed from portions of the process depicted in FIGS. 7 and 8. At 210, the age of queued notifications are updated. At 212, a determination is made as to whether a notification has expired. If so, the expired notification is removed from the queue. If no notifications have expired at 212, the process returns/proceeds to the process depicted in FIG. 8.

Referring now to FIG. 8, a decision is made at 220 regarding the branch from 206 of FIG. 7. At 220, a determination is made as to whether the user is at the desktop. If so, the process proceeds to 224 wherein the specific notification is removed from the queue, the notification is displayed, and a notification journal is updated. If the user is not present at the desktop at 220, a determination is made at 228 whether a user mobile device is enabled. If not, the process updates the notification journal. If the mobile device is enabled at 228, the process proceeds to 230. At 230, a determination is made as to whether a calendar indicates an uninterruptible meeting. If so, the notification journal is updated and the user is alerted after the meeting. If such a meeting is not in place at 230, the notification is transmitted to the mobile device and the notification journal is updated.

Referring to 240, a return is provided from the acts of 210-216 depicted in FIG. 7. At 240, a determination is made as to whether the user is present at the desktop. If so, a determination is made at 242 as to whether any notifications have reached the max deferral time set at 208 of FIG. 7. If so, the process proceeds to 244 and removes the specific notification from the queue and proceeds to 228 which has previously been described. At 240, if the user has just returned to the desktop, unseen notifications are rendered and the notification journal is updated. If the user has been at the desktop at 240, the process proceeds to 248. At 248 a determination is made as to whether any likely available states have been detected. If so, pending notifications are rendered and the notification journal is updated. If a likely available state has not been detected at 248, the process proceeds to 250. At 250, a determination is made as to whether any notifications have reached the max deferral time set at 208 of FIG. 7. If so, the process proceeds to 224 and removes the specific notification from the queue and proceeds to display the notification and update the notification journal.

Turning now to FIG. 9, a tool 260, such as a user interface, is provided for configuring deferral policies in accordance with an aspect of the present invention. The tool 260 can be utilized for assessing one or more points of mapping a continuous priority to a function that yields a deferral bound via extrapolation from one or more other points. For example, a deadline adjustment field 262, a context field 264, and a fallback field 266 can be provided. As an example, context inputs 268 can be utilized to change the deferral times for different urgencies of one or more items (e.g., busy working, meeting, critical meeting, after hours). However, context can also be employed to overlay categorical deferral policies on the time bounds. For example, in this specification, a user utilizes context-specific priority thresholds on top of a bounded deferral policy to control alerting wherein, the user can set global policy about what to do in the fallback field 266. For example, if a message will not be able to be delivered by a time bound, in a context according to the context-based controls 268 then alternative deliveries selections 270 can include send immediately, try best to wait for a good time, but never go over a deadline, and allow a deadline to pass, but wait for a good time.

Referring now to FIG. 10, a system 310 illustrates a priorities system 312 and notification architecture in accordance with an aspect of the present invention. In contrast to the user-defined priorities illustrated above in FIGS. 1-4, the system 310 provides an automated system for determining and assigning message priority, importance and/or urgency. This system 310 can be utilized with the bounded deferral policies and notifications described above. The priorities system 312 receives one or more messages or notifications 314, generates a priority or measure of importance (e.g., probability value that the message is of a high or low importance) for the associated message, and provides the one or more messages with an associated priority value at an output 316. As will be described in more detail below, classifiers can be constructed and trained to automatically assign measures of priorities to the messages 314. For example, the output 316 can be formatted such that messages are assigned a probability that the message belongs in a category of high, medium, low or other degree category of importance. The messages can be automatically sorted in an in box of an e-mail program (not shown), for example, according to the determined category of importance. The sorting can also include directing files to system folders having defined labels of importance. This can include having folders labeled with the degree of importance such as low, medium and high, wherein messages determined of a particular importance are sorted to the associated folder. Similarly, one or more audio sounds or visual displays (e.g., icon, symbol) can be adapted to alert the user that a message having a desired priority has been received (e.g., three beeps for high priority message, two beeps for medium, one beep for low, red or blinking alert symbol for high priority, green and non-blinking alert symbol indicating medium priority message has been received).

According to another aspect of the present invention, a notification platform 317 can be employed in conjunction with the priorities system 312 to direct prioritized messages to one or more notification sinks accessible to users. As will be described in more detail below, the notification platform 317 can be adapted to receive the prioritized messages 316 and make decisions regarding when, where, and how to notify the user, for example. As an example, the notification platform 317 can determine a communications modality (e.g., current notification sink 318 of the user such as a cell phone, or Personal Digital Assistant (PDA)) and likely location and/or likely focus of attention of the user. If a high importance e-mail were received, for example, the notification platform 317 can determine the users location/focus and direct/reformat the message to the notification sink 318 associated with the user. If a lower priority message 316 were received, the notification platform 317 can be configured to leave the e-mail in the user's in-box for later review as desired, for example. As will be described in more detail below, other routing and/or alerting systems 319 may be utilized to direct prioritized messages 316 to users and/or other systems.

In the following section of the description, the generation of a priority for text files such as an e-mail is described via an automatic classification system and process. The generation of priorities for texts as described can then be employed in other systems, such as a notification platform that are described in more detail below. The description in this section is provided in conjunction with FIG. 11 and FIG. 12, the former which is a diagram illustrating explicit and implicit training of a text classifier, and the latter which is a diagram depicting how a priority for a text is generated by input to the text classifier. The description is also provided in conjunction with FIGS. 13 and 14, which are diagrams of different schema according to which the priority of a text can be classified, and in conjunction with FIG. 15, which are graphs illustrating cost functions that may be applicable depending on text type.

Referring now to FIG. 1, a text/data classifier 320 can be trained explicitly, as represented by the arrow 322, and implicitly, as represented by the arrow 324 to perform classification in terms of priority. Explicit training represented by the arrow 322 is generally conducted at the initial phases of constructing the classifier 320, while the implicit training represented by the arrow 324 is typically conducted after the classifier 320 has been constructed—to fine tune the classifier 320, for example, via a background monitor 334. Specific description is made herein with reference to an SVM classifier, for exemplary purposes of illustrating a classification training and implementation approach. Other text classification approaches include Bayesian networks, decision trees, and probabilistic classification models providing different patterns of independence may be employed. Text classification as used herein also is inclusive of statistical regression that is utilized to develop models of priority.

According to one aspect of the invention Support Vector Machines (SVM) which are well understood are employed as the classifier 320. It is to be appreciated that other classifier models may also be utilized such as Naive Bayes, Bayes Net, decision tree and other learning models. SVM's are configured via a learning or training phase within a classifier constructor and feature selection module 326. A classifier is a function that maps an input attribute vector, x=(x1, x2, x3, x4, xn ), to a confidence that the input belongs to a class—that is, f(x?)=confidence(class). In the case of text classification, attributes are words or phrases or other domain-specific attributes derived from the words (e.g., parts of speech, presence of key terms), and the classes are categories or areas of interest (e.g., levels of priorities).

An aspect of SVMs and other inductive-learning approaches is to employ a training set of labeled instances to learn a classification function automatically. The training set is depicted within a data store 330 associated with the classifier constructor 326. As illustrated, the training set may include a subset of groupings G1 through GN that indicate potential and/or actual elements or element combinations (e.g., words or phrases) that are associated with a particular category. The data store 330 also includes a plurality of categories 1 through M, wherein the groupings can be associated with one or more categories. During learning, a function that maps input features to a confidence of class is learned. Thus, after learning a model, categories are represented as a weighted vector of input features.

For category classification, binary feature values (e.g., a word occurs or does not occur in a category), or real-valued features (e.g., a word occurs with an importance weight r) are often employed. Since category collections may contain a large number of unique terms, a feature selection is generally employed when applying machine-learning techniques to categorization. To reduce the number of features, features may be removed based on overall frequency counts, and then selected according to a smaller number of features based on a fit to the categories. The fit to the category may be determined via mutual information, information gain, chi-square and/or substantially any other statistical selection technique. These smaller descriptions then serve as an input to the SVM. It is noted that linear SVMs provide suitable generalization accuracy and provide suitably fast learning. Other classes of nonlinear SVMs include polynomial classifiers and radial basis functions and may also be utilized in accordance with the present invention.

The classifier constructor 326 employs a learning model 332 in order to analyze the groupings and associated categories in the data store 330 to “learn” a function mapping input vectors to confidence of class. For many learning models, including the SVM, the model for the categories can be represented as a vector of feature weights, w, wherein there can be a learned vector of weights for each category. When the weights w are learned, new texts are classified by computing the dot product of x and w, wherein w is the vector of learned weights, and x is the vector representing a new text. A sigmoid function may also be provided to transform the output of the SVM to probabilities P. Probabilities provide comparable scores across categories or classes from which priorities can be determined.

The SVM is a parameterized function whose functional form is defined before training. Training an SVM generally requires a labeled training set, since the SVM will fit the function from a set of examples. The training set can consist of a set of N examples. Each example consists of an input vector, xi, and a category label, yj, which describes whether the input vector is in a category. For each category there can be N free parameters in an SVM trained with N examples. To find these parameters, a quadratic programming (QP) problem is solved as is well understood. There is a plurality of well-known techniques for solving the QP problem. These techniques may include a Sequential Minimal Optimization technique as well as other techniques. As depicted in FIG. 12, a text input 36 that has been transformed into an input vector x is applied to the classifier 320 for each category. The classifier 320 utilizes the learned weight vectors w determined by classifier constructor 326 (e.g., one weight vector for each category) and forms a dot product to provide a priority output 338, wherein probabilities P may be assigned to the input text 36 indicating one or more associated priorities (e.g., high, medium, low).

Referring back to FIG. 11, training of the text classifier 320 as represented by the arrow 322 includes constructing the classifier in 326, including utilizing feature selection. In the explicit training phase, the classifier 320 can be presented with both time-critical and non-time-critical texts, so that the classifier may be able to discriminate between the two, for example. This training set may be provided by the user, or a standard or default training set may be utilized. Given a training corpus, the classifier 320 first applies feature-selection procedures that attempt to find the most discriminatory features. This process employs a mutual-information analysis. Feature selection can operate on one or more words or higher-level distinctions made available, such as phrases and parts of speech tagged with natural language processing. That is, the text classifier 320 can be seeded with specially tagged text to discriminate features of a text that are considered important.

Feature selection for text classification typically performs a search over single words. Beyond the reliance on single words, domain-specific phrases and high-level patterns of features are also made available. Special tokens can also enhance classification. The quality of the learned classifiers for e-mail criticality, for example, can be enhanced by inputting to the feature selection procedures handcrafted features that are identified as being useful for distinguishing among e-mail of different time criticality. Thus, during feature selection, one or more words as well as phrases and symbols that are useful for discriminating among messages of different levels of time criticality are considered.

As the following examples illustrate, tokens and/or patterns of value in identifying the criticality of messages include such distinctions as, and including Boolean combinations of the following:

Information in a Message Header

For example:

To: field (Recipient information)

Addressed just to user,

Addressed to a few people including user,

Addressed to an alias with a small number of people,

Addressed to several aliases with a small number of people,

Cc:'d to user,

Bcc:'d to user.

From: field (Sender information)

Names on pre-determined list of important people, potentially segmented into a variety of classes of individuals, (e.g., Family members, Friends)

Senders identified as internal to the user's company/organization,

Information about the structure of organizational relationships relative to the user drawn from an online organization chart such as:

Managers user reports to,

Managers of the managers of users,

People who report to the user,

External business people.

Tense Information (e.g., past, present, future)

e.g., Past tense Information

These include descriptions about events that have already occurred such as:

We met,

meeting went,

happened,

got together,

took care of,

meeting yesterday.

e.g., Future tense Information

Tomorrow,

This week,

Are you going to,

When can we,

Looking forward to,

Will this,

Will be.

Meeting and coordination Information

Get together,

Can you meet,

Will get together,

Coordinate with,

Need to get together,

See you,

Arrange a meeting,

Like to invite,

Be around.

Resolved dates

Future vs. past dates and times indicated from patterns of text to state dates and times explicitly or typical abbreviations such as:

On 5/2,

At 12:00.

Past vs. future dates, and time span between now and the date as an indicator of item urgency.

Questions

Words, phrases adjacent to questions marks (?)

Indications of personal requests:

Can you,

Are you,

Will you,

you please,

Can you do,

Favor to ask,

From you.

Indications of need:

I need,

He needs,

She needs,

I'd like,

It would be great,

I want,

He wants,

She wants,

Take care of.

Time criticality

happening soon,

right away,

deadline will be,

deadline is,

as soon as possible,

needs this soon,

to be done soon,

done right away,

this soon,

by [date],

by [time].

Importance

is important,

is critical,

Word, phrase +!,

Explicit priority flag status (low, none, high).

Length of message

Number of bytes in component of new message.

Signs of Commercial and Adult-Content Junk e-mail

Free!!,

Word+!!!,

Under 18,

Adult's only,

Percent of capitalized words,

Percent non-alphanumeric characters.

It is noted that the word or phrase groupings depicted above illustrate exemplary words, groupings, or phrases that may be utilized from which to conduct classifier training. It is to be appreciated that other similar words, groups, or phrases may be similarly employed and thus the present invention is not limited to the illustrated examples.

Furthermore, still referring to FIG. 10, implicit training of the classifier 320, as represented by the arrow 324, can be conducted by monitoring the user work or usage patterns via the background monitor 334 that can reside on the user's desktop or mobile computer, for example. For example, as users work, and lists of mail are reviewed, it can be assumed that time-critical messages are read first, and lower-priority messages are reviewed later, and/or deleted. That is, when presented with a new e-mail, the user is monitored to determine whether he or she immediately opens the e-mail, and in what order, deletes the email without opening, and/or replies to the e-mail relatively in a short amount of time. Thus, the classifier 320 is adapted such that a user is monitored while working or operating a system, the classifier is periodically refined by training in the background and updated for enhancing real-time decision-making. Background techniques for building classifiers can extend from those that update the classifier 320 with new training messages.

Alternatively, larger quantities of messages can be gathered, wherein new filters are created in a batch process, either per a daily schedule, per the number of new quantities of messages admitted to the training set, and/or combinations. For each message inputted into the classifier, for example, a new case for the classifier can be created. The cases are stored as negative and positive examples of texts that are either high or low priority, for example. As an example, one or more low, medium, and high urgency classes can be recognized such that the probabilities of membership in each of these classes are utilized to build an expected criticality. Larger numbers of criticality classes can be utilized to seek higher resolution. For example, as illustrated in FIG. 11, a training set of messages 340 (e.g., very high, high, medium, normal, low, very low, etc.) can be initially employed to train a classifier 342, such that real-time classification is achieved, as indicated at 344, wherein new messages are classified according to the number of examples resolved by the training set 340. In FIG. 11, three such categories are illustrated for exemplary purposes, however, it is to be appreciated that a plurality of such categories may be trained according to varying degrees of desired importance. As illustrated, the new messages 344 may be labeled, tagged and/or sorted into one or more folders 346, for example, according to the priorities assigned by the classifier 342. As will be described in more detail below, the assigned priorities may further be utilized by subsequent systems to make message format, delivery and modality determinations to/for the user.

According to another aspect of the invention, an estimation of a number or value can be achieved by monitoring a user interact with e-mail, for example, rather than labeling the case or message as one of a set of folders. Thus, a classifier can be continued to be updated but have a moving window, wherein cases of messages or documents that are newer than some age are considered, as specified by the user.

For example, a constant rate of loss associated with the delayed review of messages is referred to as the expected criticality (EC) of the message, wherein,

$$EC = {\sum }_{i} {C}^{d} ( {H}_{i} ) p ( {H}_{i} \vert {E}^{d} )$$

wherein C is a cost function, d is a delay, E is an event, H is the criticality class of the e-mail, and EC is expressed as the sum over the likelihood of the class(es) weighted by the rate of loss described by the cost function C for the potential class(es).

As an example, referring to FIG. 12, the text, such as an e-mail message, 336 is input into the classifier 320, which based thereon generates the priority 338 for the text 336. That is, the classifier 320 generates the priority 338, measured as a percentage from 0 to 100%, for example. This percentage can be a measure of the likelihood that the text 336 is of high or some other priority, based on the previous training of the classifier 320.

It is noted that the present invention as has been described above, the classifier 320 and the priority 338 can be based on a scheme wherein the e-mails in the training phase are construed as either high priority or low priority, for example. This scheme is illustrated in reference to FIG. 12, wherein the text classifier 320 is trained by a group of texts 347 that are predetermined to be high priority and a group of texts 347 that are predetermined to be low priority. The text 336 to be analyzed is input into the classifier 320, which outputs a scalar number 349, for example, measuring the likelihood that the text being analyzed is of high or low priority.

For example, referring to FIG. 14, a diagram illustrates a scheme wherein texts 336 are categorized into low, medium, and high priority. As described above, a plurality of other training sets may be employed to provide greater or higher resolution distinctions of priorities. The text classifier 320 is trained by a group of texts 347 that are high priority and a group of texts 348 that are low priority, and by a group of texts 350 that are medium priority. Thus, the text 336 to be analyzed is input into the classifier 320, which outputs a scalar number 349, that can measure the likelihood that the text being analyzed is of high priority, if so desired, or medium priority or low priority, for example. The classifier 320 is also able to output a class 352, which indicates the class of low, medium, or high priority that the text 336 most likely falls into. Further classes can also be added if desired.

The present invention is not limited to the definition of priority as this term is employed by the classifier 320 to assign such priority to a text such as an e-mail message. Priority can be defined in terms of a loss function, for example. More specifically, priority can be defined in terms of the expected cost in lost opportunities per time delayed in reviewing the text after it has be received. That is, the expected lost or cost that will result for delayed processing of the text. The loss function can further vary according to the type of text received.

For example, a general case is illustrated in FIG. 15, which is a graph 354 and 362 of linear and non-linear cost functions, respectively, dependent on the priority of a text. In the graph 354, as time increases, the cost of not having reviewed a text also increases. However, the cost increases more for a high priority message, as indicated by the line 356, as compared to a medium priority message, as indicated by the line 358, or a low priority message, as indicated by the line 360. For example, the high priority line 356 may have a slope of 100, the medium priority line 358 may have a slope of 10, and the low priority line 360 may have a slope of one. These slope values can then be utilized by the classifier 320 in assigning a priority to a given text, for example, by regression analysis.

Some messages, however, do not have their priorities well approximated by the use of a linear cost function. For example, a message relating to a meeting will have its cost function increase as the time of the meeting nears, and thereafter, the cost function rapidly decreases. That is, after the meeting is missed, there is not much generally a user can do about it. This situation is better approximated by a non-linear cost function, as depicted in the graph 362, a cost function 364 rapidly increases until it reaches the time of the meeting demarcated by the line 366, after which it rapidly decreases. Depending on a message's type, the cost function can be approximated by one of many different representative cost functions, both linear and non-linear.

Thus, as has been described, the priority of a text can be just likelihood that it is of one of a plurality of priorities based on the output of a classifier, or the most likely priority class the text applies to, also based on the output of the classifier. Alternatively, an expected time criticality of the text, such as an e-mail message, can determined. This can be written as:

$$EL = {{\sum }_{i}}^{n} p ( {critical}_{i} ) C ( {critical}_{i} )$$

wherein EL is the expected loss, p(criticalᵢ) is the probability that a text has the criticality i, C(criticalᵢ) is the cost function for text having the criticality i, and n is the total number of criticality classes minus one. The cost functions may be linear or non-linear, as has been described. In the case where the function is linear, the cost function defines a constant rate of loss with time. For non-linear functions, the rate of loss changes with delayed review or processing of the text and can increase or decrease, depending on the amount of delay.

In the case where n=1, specifying that there are only two priority classes low and high, the expected loss can be reformulated as:

EC=p(critical_{high})C(critical_{high})+[1−p(critical_{low})]C(critical_{low})

wherein EC is the expected criticality of a text. Furthermore, if the cost function of low criticality messages is set to zero, this becomes:

EC=p(critical_{high})C(critical_{high})

The total loss until the time of review of a text can be expressed as the integration of the expressed criticality, or,

$$EL = {\int }_{0}^{t} p ( {critical}_{high} ) C ( {critical}_{high} , t ) ⅆ t$$

wherein t is the time delay before reviewing the document.

Other measures that accord a value metric for ranking documents, such as e-mail messages, by importance. While the discussion above focused on priority as time criticality, other notions of “importance” can also be trained. For example, this can be accomplished by labeling a set of training folders: “High Importance” all the way down to “Low Importance” wherein a measure of “expected importance” can be determined. Another metric can be based on a semantic label, “messages that I would wish to hear about within 1 day while traveling” and to determine a measure for prioritizing messages for forwarding to a traveling user. Furthermore, one utilized metric is urgency or time-criticality, as it has clear semantics for decision-making, triage, and routing. In this case, the classes are labeled according to different levels of urgency and computed as an expected urgency for each message from the probabilities inferred that the message is in each class.

Extensions to criticality classification, as described in the previous section, can also be provided in accordance with the present invention. For instance, classification can include an automatic search for combinations of high-payoff features within or between classes of features. As an example, combinations of special distinctions, structures, and so forth, with words that have been found to be particularly useful for certain users can be searched for and utilized in the classification process. A combination of two features is referred as a doublet, whereas a combination of three features is referred to as a triplet, and so forth. The combination of features can enable improved classification. Classification can also be improved with the use of incremental indexing that employs a moving window in the classifier. This enables the classifier to be routinely refreshed, as old data is timed out, and new data is brought in.

Classification can also be based on the determination of the date and time of an event specified in a message. This determination can assign features to the message that can be utilized by the classifier. For example, the features assigned may include: today within four hours, today within eight hours, tomorrow, this week, this month, and next month and beyond. This enables the classifier to have improved accuracy with respect to the messages that are classified. In general, classification can be based on the time of the referenced event, considering whether the event is in the future or has past. With respect to future events, classification thus considers the sender's reference to a time in the future when the event is to occur.

Other new features can also be integrated into the classification process. For example, an organization chart can be utilized to determine how important a message is by the sender's location within the chart. Linguistic features may be integrated into the classifier. To accommodate different languages, the features may be modified depending on the origin of the sender, and/or the language in which the message is written. Classification may vary depending on different folders in which messages are stored, as well as other scaling and control rules. In addition to e-mail and other sources, classification can be performed on instant messages, and other sources of information, such as stock tickers, and so forth.

In general, a sender-recipient structural relationship may be considered in the classification process. If the user is substantially the only recipient of a message, for example, then this message may be considered as more important than a message sent to a small number of people. In turn, a message sent to a small number of people may be more important than a message on which the user is blind-copied (bcc'ed) or carbon-copied (cc'ed). With respect to the sender, criticality may be assigned based on whether the sender's name is recognized. Criticality may also be assigned depending on whether the sender is internal or external to the organization of which the user is associated.

Other distinctions that may be considered in classification include the length of the message, whether questions have been detected, and whether the user's name is in the message. Language associated with time criticality may increase the message's importance. For example, phrases such as “happening soon,” “right away,” “as soon as possible,” “ASAP,” and “deadline is,” may render the message more critical. Usage of past tense as compared to future tense may be considered, as well as coordinative tasks specified by phrases such as “get together,” “can we meet,” and so on. Evidence of junk mail may lower the priority of a message. Predicates representing combinations, such as a short question from a sender proximate to the user in the organization chart, may also be considered in the classification process.

In the next section of the description, processes are described that provide a determination when to alert the user of a high-priority text, for example, a text that has a likelihood of being high priority greater than a user-set threshold, or greater than a threshold determined by decision-theoretic reasoning. That is, beyond knowing about time-critical messages, it is also important to decide when to alert a user to time-critical messages if the user is not directly viewing incoming e-mail, for example. In general, a cost of distracting the user from the current task being addressed to learn about the time-critical message is determined.

Alternatively, various policies for alerting and notification can be employed. These policies can be implemented within a notification platform architecture, for example, that is described in more detail below. Some of these policies include:

Setting a user-specified upper bound on the total loss. This policy would specify that a system should generate an alert when the total loss associated with the delayed review of a message exceeds some pre-specified “tolerable” loss “x”.

Another policy can be a cost-benefit analysis based on more complete decision-theoretic analysis, such as NEVA=EVTA−ECA−TC, wherein NEVA is the net expected value of alerting, EVTA is the expected value of alerting, ECA is the expected cost of alerting, and TC is the transmission cost associated with communicating a message.

In general, a user should be alerted when a cost-benefit analysis suggests that the expected loss the user would incur in not reviewing the message at time t is greater than the expected cost of alerting the user. That is, alerting should be conducted if:

EL−EC>0

wherein EL is the expected loss of non-review of the text at a current time t, and EC is the expected cost of alerting the user of the text at the current time t. The expected loss is as described in the previous section of the description.

However, the above formulation may not be the most accurate, since the user will often review the message on his or her own in the future. Therefore, in actuality, the user should generally be alerted when the expected value of alerting, referred to as EVTA, is positive. The expected value of alerting should thus consider the value of alerting the user of the text now, as opposed to the value of the user reviewing the message later on their own, without alert, minus the cost of alerting. This can be stated as:

EVA=ELₐₗₑᵣₜ−ELₙₒ₋ₐₗₑᵣₜ−EC

wherein ELₐₗₑᵣₜ is the expected loss of the user reviewing the message if he or she were to review the message now, upon being alerted, as opposed to ELₙₒ₋ₐₗₑᵣₜ, which is the expected loss of the user reviewing the message on his or her own at some point, without being alerted, minus EC, the expected cost of alerting based on a consideration of distraction and on the direct cost of the transmitting the information.

Furthermore, information from several messages can be grouped together into a single compound alert. Reviewing information about multiple messages in an alert can be more costly than an alert relaying information about a single message. Such increases in distraction can be represented by making the cost of an alert a function of its informational complexity. It can be assumed that the EVA of an e-mail message is independent of the EVA of other e-mail messages. EVA(Mᵢ,t), for example, refers to the value of alerting a user about a single message Mᵢ at time t and ECA(n) refers to the expected cost of relaying the content of n messages. Thus, multiple messages can be considered by summing together the expected value of relaying information about a set of n messages, wherein:

$$NEVA = {\sum }_{i = 1} EVA ( {M}_{i} , t ) - ECA ( n ) .$$

It is also noted that in order to determine the expect cost of alerting, it is useful to infer or directly access information about whether the user is present or is not present. Sensors can be employed that indicate when a user is in the office, such as infrared sensors and pressure sensors. However, if such devices are not available, a probability that a user is in the office can be assigned as a function of user activity on the computer, for example, such as the time since last observed mouse or keyboard activity. Furthermore, scheduling information available in a calendar can also be employed to make inferences about the distance and disposition of a user and to consider the costs of forwarding messages to the user by different processes.

It is also important to know how busy the user is in making decisions about interrupting the user with information about messages with high time criticality. It can be reasoned (e.g., inferential decision-making) about whether and the rate at which a user is working on a computer, or whether the user is on the telephone, speaking with someone, or at a meeting at another location. Several classes of evidence can be employed to assess a user's activity or his or her focus of attention, as illustrated in FIG. 16. A Bayesian network can then be utilized for performing an inference about a user's activity. An example of such a network is depicted in FIG. 17.

In general, a decision should be made as to when and how to alert users to messages and to provide services based on the inference of expected criticality and user activity. Decisions can be performed by utilizing decision-models, for example. FIGS. 18-20 are influence diagrams illustrating how such decision models can be utilized to make alerting decisions. FIG. 18 displays a decision model for decisions about interrupting a user, considering current activity, expected time criticality of messages, and cost of alerting depending on the communications modality. FIG. 19 also includes variables representing the current location and the influence of that variable on activity and cost of alternate messaging techniques. Furthermore, FIG. 20 is expanded to consider the costs associated with losses in fidelity when a message with significant graphics content is forwarded to a user without the graphical content being present.

Alternatively, decisions as to when and how to alert users can be made by employment of a set of user-specified thresholds and parameters defining policies on alerting. User presence can be inferred based on mouse or keyboard activity, for example. Thus, a user can be enabled to input thresholds on alerting for inferred states of activity and non-activity, for example. Users can also input an amount of idle activity following activity wherein alerting will occur at lower criticalities. If it is determined that the user is not available based on the time that substantially no computer activity is detected, then messages can be stored, and are reported to the user in order of criticality when the user returns to interact with the computer. Furthermore, users can specify routing and paging options as a function of quantities including expected criticality, maximum expected loss, and value of alerting the user.

A notification and/or alerting system may also estimate when the user is expected to return, such that it transmits priorities that are expected to be important before the user is expected to return. This can be achieved by learning user-present and user-away patterns over time. The user can then set suitable policies in terms of when he or she is expected to return to the system to review the priorities without being alerted to them. The expected time to return determination by the system may be automatically conveyed to senders of highly urgent messages, for example. In this manner, message senders receive feedback when the user is expected to return such that he or she can reply to the messages. The sender may also be informed that his or her message has been conveyed to the user's mobile device, and so forth.

FIG. 21 illustrates a methodology for generating priorities and performing alerting decisions based on the priorities in accordance the present invention. While, for purposes of simplicity of explanation, the methodology is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Referring to FIG. 21, a flowchart diagram 374 illustrates a methodology wherein priorities are generated and utilized in accordance with the present invention. At 380, a data, such as text to have a priority thereof assigned is received. The data can be an e-mail message, or substantially any other type of data or text. At 382, a priority for the data is generated, based on a classifier, as has been described. Additionally, 382 can include initial and subsequent training of the classifier, as has been described.

The priority of the data is then output at 384. As indicated in FIG. 21, this can include processing at 386, 388, 390, 392, and 394. At 386, an expected loss of non-review of the data at a current time t is determined. This determination considers the expected loss of now-review of the text at a future time, based on an assumption that the user will review the text him or herself, without being alerted, as has been described. At 388, an expected cost of alerting is determined, as has also been described. If the loss is greater than the cost at 390, then no alert is made at the time t 392, and the process proceeds back to 386, at a new current time t. Proceeding back to 386 may be performed since as time progresses, the expected loss may at some point outweigh the alert cost, such that the calculus at 390 can change. Upon the expected loss outweighing the alert cost, then an alert to the user or other system is performed at 394.

The output of the alert to a user or other system is now described. A user can be alerted on an electronic device based on alert criteria, which indicates when the user should be alerted of a prioritized text. The electronic device on which the user is alerted can be a pager, cellular telephone, or other communications modality as described in more detail below. Alerts to a user on an electronic device, such as a pager or a cellular phone, can be based on alert criteria that can be adapted to be sensitive to information about the location, inferred task, and/or focus of attention of the user, for example. Such information can be inferred under uncertainty or can be accessed from online information sources. The information from an online calendar, for example, can be adapted to control criteria employed to make decisions about relaying information to a device, such as a notification sink which is described in more detail below.

Alerts can be performed by routing the prioritized text or other data based on routing criteria. Routing of the text can include forwarding the text, and/or replying to the sender of the text, in the case where the text is e-mail. For example, a sound can be played to alert the user to a prioritized document. Alternatively, an agent or automated assistant can be opened (e.g., interactive display wizard). That is, the agent can appear on a display screen, to notify the user of the prioritized document. Furthermore, the prioritized document can be opened, such as being displayed on the screen. The document can receive focus. This can also include sizing the document based on its priority, such that the higher the priority of the document, the larger the window in which it is displayed, and/or centrally locating the document on the display based on its priority.

Referring now to FIG. 22, a diagram of a text generation and priorities system 400 in accordance with an aspect of the present invention. The system 400 includes a program 402 and a classifier 404. It is noted that the program 400 and the classifier 402 can include a computer program executed by a processor of a computer from a computer-readable medium thereof.

The program 402 generates a text for input into the classifier 404. The program includes an electronic mail program that receives e-mail, which then serve as the text. The classifier 404 generates a priority for the associated message. As described above, the classifier 404 can be a Bayesian classifier, a Support Vector Machine classifier, or other type of classifier. The priority of the text output by the classifier 404 can then be utilized in conjunction with a cost-benefit analysis, as has been described, to effectuate further output and/or alerting based thereon.

Referring next to FIG. 23, a diagram of an alternative alerting system 408 is illustrated. The system 408 of FIG. 23 includes an alerting system 410. Not shown in FIG. 23 are the program 402 and the classifier 404. However, the alerting system 410 is operatively and/or communicatively coupled to the latter. The system 410 includes a computer program executed by a processor of a computer from a computer-readable medium thereof. The alerting system 410 is communicatively coupled to the Internet 412, for example, and can be the network by which the alerting system contacts an electronic device to alert the user to a prioritized text based on an alerting criteria, for example. The network is not limited to the Internet 412, however. Thus, the alerting system is able to alert the user of a prioritized text via contacting a pager 414, a cellular phone 416, or other electronic devices capable of receiving information from a network such as the Internet 412, and are described in more detail below.

Referring next to FIG. 24, a diagram of other aspects of the present invention are illustrated. This can include a routing system 420, for example. The routing system 420 receives a prioritized text, and based on routing criteria, is able to reply to the sender of the text, in which case the system 420 is a replying mechanism. Also, based on the routing criteria, the system 420 can forward the text, for example, to a different e-mail address, in which case the system is a forwarding mechanism. The former may be useful when the user desires to indicate to the sender of a message that the user is not present, and thus may provide the sender with contact information as to how to reach the user. The latter may be useful when the user has e-mail access to a different e-mail address, such as a web-based email address, such that the user desires to be kept informed of high priority emails at the alternative address.

An alerting system 430, also depicted in FIG. 24, receives a prioritized document, and based on a predetermined criteria (e.g., priority above an importance or urgency threshold), can display receive text, and/or provide a sound, as has been described. Of the documents that have been received by the system 430, and that have a priority greater than a predetermined threshold, for example, can be displayed as a prioritized list with associated priority labels and/or display formats adapted to the priority as described above.

The system 430 can include other functionality as well. For example, a priorities-oriented viewer (not shown) can be provided that performs as a view onto a user's e-mail store, in terms of its ability to filter by priority. The viewer can enable summaries of messages to be sorted in a list by priority score, for example. The viewer can also enable a user to sort and view only those messages that remain unread as an option. The viewer can also enable users to scope the sorting of messages by priority within some scoped time period, and to change the scope or periods being considered. For example, a user can specify that the viewer only display e-mail from today. Alternatively, the user can specify that the priorities list span two days, one week, or all the messages in the in-box. The viewer can also let the user prune from the display messages below a user-specified minimal threshold.

Furthermore, beyond the use of qualitatively different sounds for low, medium, and high priorities, one or more scalar parameters can be utilized that define the manner by which an alerting sound is rendered. The parameters can be functions of an inferred priority. Such parameters include variables that such as the volume of the alerting sound, for example, to continuous changes in the modulation or resonance of the sound.

Other functionality can be provided to users to define thresholds among different ranges of uncertainty, and wherein users can specify multiple options involving the automation of the sizing and centering of messages within each range. For example, A “While Away” briefer can be included to give the user a summary of messages that have arrived while a user was away or busy with another application. The system can be configured to bring up a summary of e-mail directed by priority values when a user returns after being away, or comes back to the viewer after working with the system in a quiet mode. The automated text summarizer can be controlled to decrease a summarization level of the text of messages as a function of the priority of the document. That is, as documents increase in priority, they are less and less summarized in the summarized view. The priorities can also be utilized to color or add other annotations, such as priority flags, icons indicating level of priority, and a special priority field itself, to e-mail headers appearing in the display.

Furthermore, a user-defined threshold can be utilized on the priority assigned to messages to set up a temporary interaction context that is active for some portion of time following an alert or summary that a message has arrived exceeding the threshold. Following an alert, and lasting for the time period that an interaction context is active, predetermined gestures are enabled to give the user access to more details about the message that was associated with the alert. Such gestures include a simple wiggle of the mouse from side to side, for example. As an example, an audio alert may indicate that an incoming message has exceeded some threshold of criticality. The user can then wiggle the mouse quickly from side to side to see details about the message that led to the alert.

The amount of time that such an interaction context is active can be made a function of the priority of the message, or can be user-defined.

Turning now to FIG. 25, a system 500 illustrates a notification architecture and priorities system according to another aspect of the present invention and in accordance with the bounded deferral policies and schema described above. The system 500 includes a context analyzer 522, a notification manager 524 (also referred to as an event broker), one or more notification sources 1 through N, 526, 527, 228, a priorities system 530 which can operate as a notification source and one or more notification sinks, 1 through M, 536, 537, 538, wherein N an M are integers, respectively. The sources are also referred to as event publishers, while the sinks are also referred to as event subscribers.

There can be any number of sinks and sources. In general, the notification manager 524 conveys notifications, which are also referred to as events or alerts, from the sources 526-528 to the sinks 536-538, based in part on parametric information stored in and/or accessed by the context analyzer 522.

The context analyzer 522 stores/analyzes information regarding variables and parameters of a user that influence notification decision-making. For example, the parameters may include contextual information, such as the user's typical locations and attentional focus or activities per the time of day and the day of the week, and additional parameters conditioned on such parameters, such as the devices users tend to have access to in different locations. Such parameters may also be functions of observations made autonomously via one or more sensors. For example, one or more profiles (not shown) may be selected or modified based on information about a user's location as can be provided by a global positioning system (GPS) subsystem, on information about the type of device being used and/or the pattern of usage of the device, and the last time a device of a particular type was accessed by the user. Furthermore, as is described in more detail below, automated inference may also be employed, to dynamically infer parameters or states such as location and attention. The profile parameters may be stored as a user profile that can be edited by the user. Beyond relying on sets of predefined profiles or dynamic inference, the notification architecture can enable users to specify in real-time his or her state, such as the user not being available except for important notifications for the next “x” hours, or until a given time, for example.

The parameters can also include default notification preference parameters regarding a user's preference as to being disturbed by notifications of different types in different settings, which can be used as the basis from which to make notification decisions by the notification manager 524, and upon which a user can initiate changes. The parameters may include default parameters as to how the user wishes to be notified in different situations (e.g., such as by cell phone, by pager). The parameters can include such assessments as the costs of disruption associated with being alerted by different modes in different settings. This can include contextual parameters indicating the likelihoods that the user is in different locations, the likelihoods that different devices are available, and the likelihoods of his or her attentional status at a given time, as well as notification parameters indicating how the user desires to be notified at a given time.

Information stored by the context analyzer 522, according to one aspect of the present invention is inclusive of contextual information determined by the analyzer. The contextual information is determined by the analyzer 522 by discerning the user's location and attentional status based on one or more contextual information sources (not shown), as is described in more detail in a later section of the description. The context analyzer 522, for example, may be able to determine with precision the actual location of the user via a global positioning system (GPS) that is a part of a user's car or cell phone. The analyzer may also employ a statistical model to determine the likelihood that the user is in a given state of attention by considering background assessments and/or observations gathered through considering such information as the type of day, the time of day, the data in the user's calendar, and observations about the user's activity. The given state of attention can include whether the user is open to receiving notification, busy and not open to receiving notification, and can include other considerations such as weekdays, weekends, holidays, and/or other occasions/periods.

The sources 526-528, 530 generate notifications intended for the user and/or other entity. For example, the sources 526-530 may include communications, such as Internet and network-based communications, local desktop computer-based communications, and telephony communications, as well as software services, such as intelligent help, background queries, and automated scheduling. Notification sources are defined generally herein as that which generates events, which can also be referred to as notifications and alerts, intended to alert a user, or a proxy for the user, about information, services, and/or a system or world event. A notification source can also be referred to as an event source.

For example, e-mail may be generated as notifications by an the priorities system 530 such that it is prioritized, wherein an application program or system generating the notification assigns the e-mail with a relative priority corresponding to the likely importance or urgency of the e-mail to the user. The e-mail may also be sent without regard to the relative importance to the user. Desktop-centric notifications can include an automated dialog with the goal of alerting a user to a potentially valuable service that he or she may desire to execute (e.g., scheduling from a message), information that the user may desire to review (e.g., derived from a background query), or errors and/or other alerts generated by a desktop computer. Internet-related services can include notifications including information that the user has subscribed to, such as headlines of current news every so often, and stock quotes, for example.

Other notifications can include background queries (e.g., while the user is working, text that the user is currently working on may be reviewed, such that background queries regarding the text are formulated and issued to search engines), and scheduling tasks from a scheduling and/or other program. Notification sources 526-530 can themselves be push-type or pull-type sources. Push-type sources are those that automatically generate and send information without a corresponding request, such as headline news and other Internet-related services that send information automatically after being subscribed to. Pull-type sources are those that send information in response to a request, such as e-mail being received after a mail server is polled. Still other notification sources include the following:

e-mail desktop applications such as calendar systems;

computer systems (e.g., that may alert the user with messages that information about alerts about system activity or problems);

Internet-related services, appointment information, scheduling queries;

changes in documents or numbers of certain kinds of documents in one or more shared folders;

availability of new documents in response to standing or persistent queries for information; and/or,

information sources for information about people and their presence, their change in location, their proximity (e.g., let me know when I am traveling if another coworker or friend is within 10 miles of me”), or their availability (e.g., let me know when Steve is available for a conversation and is near a high-speed link that can support full video teleconferencing”).

The notification sinks 536-538 are able to provide notifications to the user. For example, such notification sinks 536-538 can include computers, such as desktop and/or laptop computers, handheld computers, cell phones, landline phones, pagers, automotive-based computers, as well as other systems/applications as can be appreciated. It is noted that some of the sinks 536-538 can convey notifications more richly than other of the sinks. For example, a desktop computer typically has speakers and a relatively large color display coupled thereto, as well as having a higher bandwidth for receiving information when coupled to a local network or to the Internet. Thus, notifications can be conveyed by the desktop computer to the user in a relatively rich manner. Conversely, many cell phones have a smaller display that can be black and white, and receive information at a relatively lower bandwidth, for example. Correspondingly, the information associated with notifications conveyed by cell phones may generally be shorter and geared towards the phone's interface capabilities, for example. Thus, the content of a notification may differ depending on whether it is to be sent to a cell phone or a desktop computer. According to one aspect of the present invention, a notification sink can refer to that which subscribes, via an event subscription service, for example, to events or notifications.

The notification manager 524 accesses the information stored and/or determined by the context analyzer, and determines which of the notifications received from the sources 526-530 to convey to which of the sinks 536-538. Furthermore, the notification manager 524 can determine how the notification is to be conveyed, depending on which of the sinks 536-538 has been selected to send the information to. For example, it may be determined that notifications should be summarized before being provided to a selected sinks 536-538.

The invention is not limited to how the manager 524 makes its decisions as to which of the notifications to convey to which of the notification sinks, and in what manner the notifications are conveyed. In accordance with one aspect, a decision-theoretic analysis can be utilized. For example, the notification manager 524 can be adapted to infer important uncertainties about variables including a user's location, attention, device availability, and amount of time until the user will access the information if there were no alert. The notification manager 524 can then make notification decisions about whether to alert a user to a notification, and if so, the nature of the summarization and the suitable device or devices to employ for relaying the notification. In general, the notification manager 524 determines the net expected value of a notification. In doing so, it can consider the following:

the fidelity and transmission reliability of each available notification sink;

the attentional cost of disturbing the user;

the novelty of the information to the user;

the time until the user will review the information on his or her own;

the potentially context-sensitive value of the information; and/or,

the increasing and/or decreasing value over time of the information contained within the notification.

Inferences made about uncertainties thus may be generated as expected likelihoods of values such as the cost of disruption to the user with the use of a particular mode of a particular device given some attentional state of the user, for example. The notification manager 524 can make decisions as to one or more of the following:

what the user is currently attending to and doing (based on, for example, contextual information);

where the user currently is;

how important the information is;

what is the cost of deferring the notification;

how distracting would a notification be;

what is the likelihood of getting through to the user; and,

what is the fidelity loss associated with the use of a specific mode of a given notification sink.

Therefore, the notification manager 524 can perform an analysis, such as a decision-theoretic analysis, of pending and active notifications, evaluates context-dependent variables provided by information sinks and sources, and infers selected uncertainties, such as the time until a user is likely to review information and the user's location and current attentional state.

As used herein, inference refers generally to the process of reasoning about or inferring states of the system 500, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the notification manager 524 can access information stored in a user profile by the context analyzer 522 in lieu of or to support a personalized decision-theoretic analysis. For example, the user profile may indicate that at a given time, the user prefers to be notified via a pager, and only if the notification has a predetermined importance level. Such information can be utilized as a baseline from which to start a decision-theoretic analysis, or can be the manner by which the notification manager 524 determines how and whether to notify the user.

According to one aspect of the present invention, the notification platform architecture 500 can be configured as a layer that resides over an eventing or messaging infrastructure. However, the invention is not limited to any particular eventing infrastructure. Such eventing and messaging systems and protocols can include:

HyperText Transport Protocol (HTTP), or HTTP extensions as known within the art;

Simple Object Access Protocol (SOAP), as known within the art;

Windows Management Instrumentation (WMI), as known within the art;

Jini, as known within the art; and,

substantially any type of communications protocols, such as those based on packet-switching protocols, for example.

Furthermore, the architecture can be configured as a layer that resides over a flexible distributed computational infrastructure, as can be appreciated by those of ordinary skill within the art. Thus, the notification platform architecture can utilize an underlying infrastructure as a manner by which sources send notifications, alerts and events, and as a manner by which sinks receive notifications, alerts and events, for example. The present invention is not so limited, however.

Referring Now to FIG. 26, the context analyzer 522 of the notification architecture described in the previous section of the description is depicted in more detail. The context analyzer 522 as illustrated in FIG. 26 includes a user notification preferences store 552, a user context module 554 that includes a user context profile store 555, and a whiteboard 557. The context analyzer 522 according to one aspect of the invention can be implemented as one or more computer programs executable by a processor of a computer from a machine-readable medium thereof, such as a memory.

The preferences store 552 stores notification parameters for a user, such as default notification preferences for the user, such as a user profile, which can be edited and modified by the user. The preferences store 552 can be considered as that which stores information on parameters that influence how a user is to be notified. The user context module 554 determines a user's current context, based on one or more context information sources 560 as published to the whiteboard 557, for example. The user context profile store 555 stores context parameters for a user, such as the default context settings for the user, which can be edited and modified by the user. That is, the user context module 554 provides a best guess or estimate about a user's current context information by accessing information from the profile store 555 and/or updating a prior set of beliefs in the store 555 with live sensing, via the one or more context sources 560. The profile store 555 can be considered as that which stores a priori where a user is, and what the user is doing, for example.

The user context profile store 555 can be a pre-assessed and/or predefined user profile that captures such information as a deterministic or probabilistic profile. The profile can be of typical locations, activities, device availabilities, and costs and values of different classes of notification as a function of such observations as time of day, type of day, and user interactions with one or more devices. The type of day can include weekdays, weekends and holidays, for example. The user context module 554 can then actively determine or infer aspects of the user's context or state, such as the user's current or future location and attentional state. Furthermore, actual states of context can be accessed directly from the context information sources 560 via the whiteboard 557, and/or, can be inferred from a variety of such observations through inferential methods such as Bayesian reasoning as is described in more detail below.

The context information sources 560 provide information to the context module 554 via the whiteboard 557 regarding the user's attentional state and location, from which the module 554 can make a determination as to the user's current context (e.g., the user's current attentional state and location). Furthermore, the invention is not limited to a particular number or type of context sources 560, nor the type of information inferred or accessed by the user context module 554. However, the context sources 560 can include multiple desktop information and events, such as mouse information, keyboard information, application information (e.g., which application is currently receiving the focus of the user), ambient sound and utterance information, text information in the windows on the desktop, for example. The whiteboard 557 can include a common storage area, to which the context information sources 560 can publish information, and from which multiple components, including sources and the context module 554 can access this information. An event, also referred to as a notification or alert, generally can include information about an observation about one or more states of the world. Such states can include the status of system components, the activity of a user, and/or a measurement about the environment. Furthermore, events can be generated by an active polling of a measuring device and/or source of events, by the receipt of information that is sent on a change, and/or per a constant or varying event heartbeat.

Other types of context sources 560 includes personal-information manager (PIM) information of the user, which generally can provide scheduling information regarding the schedule of the user, for example. The current time of day, as well as the user's location—for example, determined by a global positioning system (GPS), and/or a user's access of a cell phone, PDA, or a laptop that can be locationally determined—are also types of context sources 560. Furthermore, real-time mobile device usage is a type of context source 560. For example, a mobile device such as a cell phone may be able to determine if it is currently being accessed by the user, as well as device orientation and tilt (e.g., indicating information regarding device usage as well), and acceleration and speed (e.g., indicating information as to whether the user is moving or not).

Referring now to FIG. 27, the notification sources described above are illustrated in more detail. The notification sources 526-528, and/or 530 generally generate notifications that are conveyed to the notification manager 524, which determines when notifications should occur, and, if so, which of the notifications should be conveyed to which of the notification sinks 536-538 and in what order.

According to one aspect of the present invention, notification sources 526-528 can have one or more of the following parameters within a standard description of attributes and relationships, referred to herein as a notification source schema or source schema. It is noted that schema can be provided for sources, for sinks, and for context-information sources, described above. Such schemas provide declarative information about different components and can enable the sources 526-528, 530, the notification manager 524, the sinks 536-538, and the context analyzer 522 to share semantic information with one another. Thus, different schemas provide information about the nature, urgency, and device signaling modalities associated with notification. That is, schema can be defined generally as a collection of classes and relationships among classes that defines the structure of notifications and events, containing information including event or notification class, source, target, event or notification semantics, ontological content information, observational reliability, and substantially any quality-of-service attributes, for example.

Parameters (not shown) for notification source schema can include one or more of: message class; relevance; importance; time criticality; novelty; content attributes; fidelity tradeoffs, and/or source information summary information. The message class for a notification generated by a notification source indicates the type of communication of the notification, such as e-mail, instant message, numerical financial update, and desktop service, for example. The relevance for a notification generated by notification sources indicates a likelihood that the information contained within the notification is relevant, for one or more specified contexts. For example, the relevance can be provided by a logical flag, indicating whether the source is relevant for a given context or not. The novelty of the notification indicates the likelihood that the user already knows the information contained within the notification. That is, the novelty is whether the information is new to the user, over time (indicating if the user knows the information now, and when, if ever, the user will learn the information in the future without being alerted to it).

Fidelity tradeoffs associated with the notification indicate the loss of value of the information within the notification that can result from different forms of specified allowed truncation and/or summarization, for example. Such truncation and/or summarization may be required for the notification to be conveyed to certain types of notification sinks 536-538 that may have bandwidth and/or other limitations preventing the sinks from receiving the full notification as originally generated. Fidelity in general refers to the nature and/or degree of completeness of the original content associated with a notification. For example, a long e-mail message may be truncated, or otherwise summarized to a maximum of 100 characters allowed by a cell phone, incurring a loss of fidelity. Likewise, an original message containing text and graphics content suffers a loss in fidelity when transmitted via a device that only has text capabilities. In addition, a device may only be able to depict a portion of the full resolution available from the source. Fidelity tradeoffs refer to a set of fidelity preferences of a source stated either in terms of orderings (e.g., rendering importance in order of graphics first, then sound) and/or costs functions that indicate how the total value of the content of the notification diminishes with changes in fidelity. For example, a fidelity tradeoff can describe how the full value associated with the transmission of a complete e-mail message changes with increasingly greater amounts of truncation. Content attributes, for example, can include a summary of the nature of the content, representing such information as whether the core message includes text, graphics, and audio components. The content itself is the actual graphics, text, and/or audio that make up the message content of the notification.

The importance of a notification refers to the value of the information contained in the notification to the user, assuming the information is relevant in a current context. For example, the importance can be expressed as a dollar value of the information's worth to the user. Time criticality indicates time-dependent change in the value of information contained in a notification—that is, how the value of the information changes over time. In most but not all cases, the value of the information of a notification decays with time. This is illustrated in the diagram of FIG. 28. A graph 580 depicts the utility of a notification mapped over time. At the point 584 within the graph, representing the initial time, the importance of the notification is indicated, while the curve 586 indicates the decay of the utility over time.

Referring back to FIG. 27, default attributes and schema templates for different notification sources or source types may be made available in notification source profiles stored in the user notification preferences store, such as the store 552 of FIG. 26. Such default templates can be directed to override values provided by notification sources or to provide attributes when they are missing from schema provided by the sources. Source summary information enables a source to post general summaries of the status of information and potential notifications available from a source. For example, source summary information from a messaging source may include information about the total number of unread messages that are at least some priority, the status of attempts by people to communicate with a user, and/or other summary information.

The notification sinks 536-538 can be substantially any device or application by which the user or other entity can be notified of information contained in notifications. The choice as to which sink or sinks are to be employed to convey a particular notification is determined by the notification manager 524.

Notification sinks 536-538 may have one or more of the following parameters provided within a schema. These parameters may include a device class; modes of signaling (alerting); and, for the associated mode, fidelity/rendering capabilities, transmission reliability, actual cost of communication, and/or attentional cost of disruption, for example. For devices that are adapted for parameterized control of alerting attributes, the schema for the devices can additionally include a description of the alerting attributes and parameters for controlling the attributes, and functions by which other attributes (e.g., transmission reliability, cost of distribution) change with the different settings of the alerting attributes. The schema for notification sinks provides for the manner by which the notification devices communicate semantic information about their nature and capabilities with the notification manager 524 and/or other components of the system. Default attributes and schema templates for different device types can be made available in device profiles stored in the user notification preferences store, such as the store 552 of FIG. 26 as described in the previous section. Such default templates can be directed to override values provided by devices or to provide attributes when they are missing from schema provided by such devices.

Each of the schema parameters is now described in term. The class of the device refers to the type of the device such as a cell phone, a desktop computer, and a laptop computer, for example. The class can also be more general, such as a mobile or a stationery device. The modes of signaling refer to the manner in which a given device can alert the user about a notification. Devices may have one or more notification modes. For example, a cell phone may only vibrate, may only ring with some volume, and/or it can both vibrate and ring. Furthermore, a desktop display for an alerting system can be decomposed into several discrete modes (e.g., a small notification window in the upper right hand of the display vs. a small thumbnail at the top of the screen—with or without an audio herald). Beyond being limited to a set of predefined behaviors, a device can enable modes with alerting attributes that are functions of parameters, as part of a device definition. Such continuous alerting parameters for a mode represent such controls as the volume at which an alert is played at the desktop, rings on a cell phone, and the size of an alerting window, for example.

The transmission reliability for a mode of a notification sink 536-538 indicates the likelihood that the user will receive the communicated alert about a notification, which is conveyed to the user via the sink with that mode. As transmission reliability may be dependent on the device availability and context of the user, the transmission reliability of different modes of a device can be conditioned on such contextual attributes as the location and attention of a user. Transmission reliability for one or more unique contextual states, defined by the cross product of such attributes as unique locations and unique attentional states, defined as disjunctions created as abstractions of such attributes (e.g., for any location away from the home, and any time period after 8 am and before noon), can also be specified. For example, depending on where the user currently is, information transmitted to a cell phone may not always reach the user, particularly if the user is in a region with intermittent coverage, or where the user would not tend to have a cell phone in this location (e.g., family holiday). Contexts can also influence transmission reliability because of ambient noise and/or other masking or distracting properties of the context.

The actual cost of communication indicates the actual cost of communicating the information to the user when contained within a notification that is conveyed to the sink. For example, this cost can include the fees associated with a cell phone transmission. The cost of disruption includes the attentional costs associated with the disruption associated with the alert employed by the particular mode of a device, in a particular context. Attentional costs are typically sensitive to the specific focus of attention of the user. The fidelity/rendering capability is a description of the text, graphics, and audio/tactile capabilities of a device, also given a mode. For example, a cell phone's text limit may be 100 characters for any single message, and the phone may have no graphics capabilities.

Turning now to FIG. 29, an interface 590 illustrates context specifications selectable by a user that can be utilized by the context analyzer 522 in determining a user's current context. The determination of user context by direct specification by the user, and/or a user-modifiable profile, is described. The context of the user can include the attentional focus of the user—that is, whether the user is currently amenable to receiving notification alerts—as well as the user's current location. The present invention is not so limited, however.

Direct specification of context by the user enables the user to indicate whether or not he or she is available to receive alerts, and where the user desires to receive them. A default profile (not shown) can be employed to indicate a default attentional state, and a default location wherein the user can receive the alerts. The default profile can be modified by the user as desired.

Referring to FIG. 29, the interface 590 illustrates how direct specification of context can be implemented, according to an aspect of the present invention. A window 591, for example, has an attentional focus section 592 and a location section 594. In the focus section 592, the user can check one or more check boxes 596, for example, indicating whether the user is always available to receive alerts; whether the user is never available to receive alerts; and, whether the user is only available to receive alerts that has an importance level greater than a predetermined threshold. It is to be appreciated that other availability selections can be provided. As depicted in FIG. 29, a threshold can be measured in dollars, but this is for exemplary purposes only, and the invention is not so limited. The user can increase the threshold in the box 598 by directly entering a new value, or by increasing or decreasing the threshold via arrows 600.

In the location section 594, the user can check one or more of the check boxes 602, to indicate where the user desires to have alerts conveyed. For example, the user can have alerts conveyed at the desktop, by e-mail, at a laptop, on a cell phone, in his or her car, on a pager, or on a personal digital assistant (PDA) device, and so forth. It is to be appreciated that these are examples only, however, and the invention itself is not so limited.

The window 591, wherein there can be preset defaults for the checkboxes 596 and the box 598 of the section 592 and the checkboxes 602 of the section 594, can be considered a default user profile. The profile is user modifiable in that the user can override the default selections with his or her own desired selections. Other types of profiles can also be utilized in accordance with the invention.

Referring now to FIG. 30, a determination of user context by direct measurement, for example, using one or more sensors, is illustrated in accordance with the present invention. The context of the user can include the user's attentional focus, as well as his or her current location. The invention itself is not so limited, however. Direct measurement of context indicates that sensor(s) can be employed to detect whether the user is currently amenable to receiving alerts, and to detect where the user currently is. According to one aspect of the present invention, an inferential analysis in conjunction with direct measurement can be utilized to determine user context, as is described in a later section of the description.

Referring to FIG. 30, a system 610 in which direct measurement of user context can be achieved is illustrated. The system 610 includes a context analyzer 612, and communicatively coupled thereto a number of sensors 614-620, namely, a cell phone 614, a video camera 615, a microphone 616, a keyboard 617, a PDA 618, a vehicle 619, and a GPS 620, for example. The sensors 614-620 depicted in FIG. 30 are for exemplary purposes only, and do not represent a limitation or a restriction on the invention itself. The term sensor as used herein is a general and overly encompassing term, meaning any device or manner by which the context analyzer 612 can determine what the user's current attentional focus is, and/or what the user's current location is.

For example, if the user has the cell phone 614 on, this can indicate that the user can receive alerts on the cell phone 614. However, if the user is currently talking on the cell phone 614, this can indicate that the user has his or her attentional focus on something else (namely, the current phone call), such that the user should not presently be disturbed with a notification alert. The video camera 615 can, for example, be in the user's office, to detect whether the user is in his or her office (viz., the user's location), and whether others are also in his or her office, suggesting a meeting with them, such that the user should not be disturbed (viz., the user's focus). Similarly, the microphone 616 can also be in the user's office, to detect whether the user is talking to someone else, such that the user should not be disturbed, is typing on the keyboard (e.g., via the sounds emanating therefrom), such that the user should also not be presently disturbed. The keyboard 617 can also be employed to determine if the user is currently typing thereon, such that, for example, if the user is typing very quickly, this may indicate that the user is focused on a computer-related activity, and should not be unduly disturbed (and, also can indicate that the user is in fact in his or her office).

If the PDA device 618 is being accessed by the user, this can indicate that the user is able to receive alerts at the device 618—that is, the location at which notifications should be conveyed is wherever the device 618 is located. The device 618 can also be utilized to determine the user's current attentional focus. The vehicle 619 can be utilized to determine whether the user is currently in the vehicle—that is, if the vehicle is currently being operated by the user. Furthermore, the speed of the vehicle can be considered, for example, to determine what the user's focus is. If the speed is greater than a predetermined speed, for instance, then it may be determined that the user is focused on driving, and should not be bothered with notification alerts. The GPS device 620 can also be employed to ascertain the user's current location, as known within the art.

In the following section of the detailed description, a determination of user context according to user-modifiable rules is described. The context of the user can include the user's attentional focus, as well as his or her current location. The invention is not so limited, however. Determining context via rules indicates that a hierarchical set of if-then rules can be followed to determine the user's location and/or attentional focus.

Referring to FIG. 31, a diagram illustrates an exemplary hierarchical ordered set of rules 630. The set of rules 630 depicts rules 632, 633, 634, 635, 636, 637 and 638, for example. It is noted that other rules may be similarly configured. As illustrated in FIG. 31, rules 633 and 634 are subordinate to 632, while rule 634 is subordinate to rule 633, and rule 638 is subordinate to rule 638. The rules are ordered in that rule 632 is first tested; if found true, then rule 633 is tested, and if rule 633 is found true, then rule 634 is tested, and so forth. If rule 633 is found false, then rule 635 is tested. If rule 632 is found false, then rule 636 is tested, which if found false, causes testing of rule 637, which if found true causes testing of rule 638. The rules are desirably user creatable and/or modifiable. Otherwise-type rules can also be included in the set of rules 630 (e.g., where if an if-then rule is found false, then the otherwise rule is controlling).

Thus, a set of rules can be constructed by the user such that the user's context is determined. For example, with respect to location, the set of rules can be such that a first rule tests whether the current day is a weekday. If it is, then a second rule subordinate to the first rule tests whether the current time is between 9 a.m. and 5 p.m. If it is, then the second rule indicates that the user is located in his or her office, otherwise the user is at home. If the first rule is found to be false—that is, the current day is a weekend and not a weekday—then an otherwise rule may state that the user is at home. It is noted that this example is not meant to be a restrictive or limiting example on the invention itself, wherein one or more other rules may also be similarly configured.

In the following section of the description, a determination of user context by inferential analysis, such as by employing a statistical and/or Bayesian model, is described. It is noted that context determination via inferential analysis can rely in some aspects on other determinations, such as direct measurement via sensor(s), as has been described. Inferential analysis as used herein refers to using an inference process(es) on a number of input variables, to yield an output variable(s), namely, the current context of the user. The analysis can include in one aspect utilization of a statistical model and/or a Bayesian model.

Referring to FIG. 32, a diagram of a system 640 is illustrated in which inferential analysis is performed by an inferential engine 642 to determine a user's context 644, according to an aspect of the present invention. The engine 642 is in one aspect a computer program executed by a processor of a computer from a computer-readable medium thereof, such as a memory. The user context 644 can be considered the output variable of the engine 642.

The engine 642 can process one or more input variables to make a context decision. Such input variables can include one or more sensor(s) 648, such as the sensor(s) that have been described in conjunction with a direct measurement approach for context determination in a previous section of the description, as well as the current time and day, as represented by a clock 650, and a calendar 652, as may be accessed in a user's scheduling or personal-information manager (PIM) computer program, and/or on the user's PDA device, for example. Other input variables can also be considered besides those illustrated in FIG. 32. The variables of FIG. 32 are not meant to be a limitation or a restriction on the invention itself.

Referring now to FIGS. 33 and 34, an exemplary inferential model, such as provided by a statistical and/or Bayesian model that can be executed by the inferential engine described above is illustrated in accordance with the present invention. In general, a computer system can be somewhat uncertain about details of a user's state. Thus, probabilistic models can be constructed that can make inferences about a user's attention or other state under uncertainty. Bayesian models can infer a probability distribution over a user's focus of attention. Such states of attention can be formulated as a set of prototypical situations or more abstract representations of a set of distinct classes of cognitive challenges being addressed by a user. Alternatively, models can be formulated that make inferences about a continuous measure of attentional focus, and/or models that directly infer a probability distribution over the cost of interruption for different types of notifications.

Bayesian networks may be employed that can infer the probability of alternate activity contexts or states based on a set of observations about a user's activity and location. As an example, FIG. 33 displays a Bayesian network 654 for inferring a user's focus of attention for a single time period. States of a variable, Focus of Attention 656, refer to desktop and non-desktop contexts. Exemplary attentional contexts considered in the model include situation awareness, catching up, nonspecific background tasks, focused content generation or review, light content generation or review, browsing documents, meeting in office, meeting out of office, listening to presentation, private time, family time, personal focus, casual conversation and travel, for example. The Bayesian network 654 indicates that a user's current attention and location are influenced by the user's scheduled appointments 658, the time of day 660, and the proximity of deadlines 662. The probability distribution over a user's attention is also in influenced by summaries of the status of ambient acoustical signals 664 monitored in a user's office, for example. Segments of the ambient acoustical signal 664 over time provide clues/inputs about the presence of activity and conversation. Status and configuration of software applications and the ongoing stream of user activity generated by a user interacting with a computer also provide sources of evidence about a user's attention.

As portrayed in the network 654, a software application currently at top-level focus 666 in an operating system or other environment influences the nature of the user's focus and task, and the status of a user's attention and the application at focus together influence computer-centric activities. Such activity includes the stream of user activity built from sequences of mouse and keyboard actions and higher-level patterns of application usage over broader time horizons. Such patterns include e-mail-centric and Word-processor centric, and referring to prototypical classes of activity involving the way multiple applications are interleaved.

FIG. 34 illustrates a Bayesian model 668 of a user's attentional focus among context variables at different periods of time. A set of Markov temporal dependencies is illustrated by the model 668, wherein past states of context variables are considered in present determinations of the user's state. In real-time, such Bayesian models 668 consider information provided by an online calendar, for example, and a stream of observations about room acoustics and user activity as reported by an event sensing system (not shown), and continues to provide inferential results about the probability distribution of a user's attention.

FIGS. 35 and 36 illustrate methodologies for providing portions of a notification architecture such as a context analyzer and a notification manager in accordance the present invention. While, for purposes of simplicity of explanation, the methodologies are shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Referring to FIG. 35, a flowchart 670 illustrates determining a user's context in accordance with the present invention. The process includes determining the user's location in 671, and the user's focus in 672. These acts can be accomplished by one or more of the approaches described previously. For example, a profile can be employed; a user can specify his or her context; direct measurement of context can be utilized; a set of rules can be followed; an inferential analysis, such as via a Bayesian or a statistical model, can also be performed. It is to be appreciated that other analysis can be employed to determine a user's context. For example, there can be an integrated video camera source that notes if someone is front of the computer and whether or not he or she is looking at the computer. It is noted, however, that the system can operate with or without a camera. For all of the sources, the system can operate with substantially any input source available, not requiring any particular source to inference about context. Furthermore, in other aspects, there can be integrated accelerometers, microphones, and proximity detectors on small PDA's that give a sense of a user's location and attention.

Referring now to FIG. 36, a flowchart diagram 673 illustrates a decision process for a notification manager in accordance with an aspect of the present invention. At 674, one or more notification sources generate notifications, which are received by a notification manager. At 675, a context analyzer generates/determines context information regarding the user, which in 676 is received by the notification manager. That is, according to one aspect of the present invention, at 675, the context analyzer accesses a user contextual information profile that indicates the user's current attentional status and location, and/or assesses real-time information regarding the user's current attentional status and location from one or more contextual information sources, as has been described in the previous sections of the description.

At 677, the notification manager determines which of the notifications to convey to which of the notification sinks, based in part on the context information received from the context analyzer. The notification manager also makes determinations based on information regarding notification parameters of the user as stored by the context analyzer. That is, according to one aspect, in 677, the manager performs a decision-theoretic analysis as to whether a user should be alerted for a given notification, and how the user should be notified. As will be described in more detail below, decision-theoretic and/or heuristic analysis, determinations and policies may be employed at 677. Notification parameters regarding the user can be utilized to personalize the analysis by filling in missing values or by overwriting parameters provided in the schema of sources or sinks. Notification preferences can also provide policies (e.g., heuristic) that are employed in lieu of the decision-theoretic analysis. Based on this determination, the notification manager conveys the notifications to the sinks at 678.

Various aspects of the invention have been described herein thus far as applicable to users. However, the invention itself is not so limited. That is, the invention is applicable to substantially any type of entity, including users. Other types of entities include agents, processes, computer programs, threads, services, servers, computers, machines, companies, organizations, and/or businesses, for example. The agent, for example, may be a software agent, which can be generally defined as a computer program that performs a background task for a user and reports to the user when the task is done or some expected event has taken place. Still other types of entities are encompassed under the invention, as can be appreciated by those of ordinary skill within the art. For example, the context analyzer according to another aspect of the invention can be generalized as a component applicable to substantially any type of entity. As another example, notification sinks can generate notifications, alerts and events regarding entities other than users. Similarly, notification sinks can receive notifications, alerts and events regarding entities other than users.

In order to provide a context for the various aspects of the invention, FIG. 37 and the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 37, an exemplary system for implementing the various aspects of the invention includes a computer 720, including a processing unit 721, a system memory 722, and a system bus 723 that couples various system components including the system memory to the processing unit 721. The processing unit 721 may be any of various commercially available processors. It is to be appreciated that dual microprocessors and other multi-processor architectures also may be employed as the processing unit 721.

The system bus may be any of several types of bus structure including a memory bus or memory controller, a peripheral bus, and a local bus using any of a variety of commercially available bus architectures. The system memory may include read only memory (ROM) 724 and random access memory (RAM) 725. A basic input/output system (BIOS), containing the basic routines that help to transfer information between elements within the computer 720, such as during start-up, is stored in ROM 724.

The computer 720 further includes a hard disk drive 727, a magnetic disk drive 728, e.g., to read from or write to a removable disk 729, and an optical disk drive 730, e.g., for reading from or writing to a CD-ROM disk 731 or to read from or write to other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer-readable media provide nonvolatile storage of data, data structures, computer-executable instructions, etc. for the computer 720. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM 725, including an operating system 735, one or more application programs 736, other program modules 737, and program data 738. It is noted that the operating system 735 in the illustrated computer may be substantially any suitable operating system.

A user may enter commands and information into the computer 720 through a keyboard 740 and a pointing device, such as a mouse 742. Other input devices (not shown) may include a microphone, a joystick, a game pad, a satellite dish, a scanner, or the like. These and other input devices are often connected to the processing unit 721 through a serial port interface 746 that is coupled to the system bus, but may be connected by other interfaces, such as a parallel port, a game port or a universal serial bus (USB). A monitor 747 or other type of display device is also connected to the system bus 723 via an interface, such as a video adapter 748. In addition to the monitor, computers typically include other peripheral output devices (not shown), such as speakers and printers.

The computer 720 may operate in a networked environment using logical connections to one or more remote computers, such as a remote computer 749. The remote computer 749 may be a workstation, a server computer, a router, a peer device or other common network node, and typically includes many or all of the elements described relative to the computer 720, although only a memory storage device 750 is illustrated in FIG. 38. The logical connections depicted in FIG. 38 may include a local area network (LAN) 751 and a wide area network (WAN) 752. Such networking environments are commonplace in offices, enterprise-wide computer networks, Intranets and the Internet.

When employed in a LAN networking environment, the computer 720 may be connected to the local network 751 through a network interface or adapter 753. When utilized in a WAN networking environment, the computer 720 generally may include a modem 754, and/or is connected to a communications server on the LAN, and/or has other means for establishing communications over the wide area network 752, such as the Internet. The modem 754, which may be internal or external, may be connected to the system bus 723 via the serial port interface 746. In a networked environment, program modules depicted relative to the computer 720, or portions thereof, may be stored in the remote memory storage device. It will be appreciated that the network connections shown are exemplary and other means of establishing a communications link between the computers may be employed.

In accordance with the practices of persons skilled in the art of computer programming, the present invention has been described with reference to acts and symbolic representations of operations that are performed by a computer, such as the computer 720, unless otherwise indicated. Such acts and operations are sometimes referred to as being computer-executed. It will be appreciated that the acts and symbolically represented operations include the manipulation by the processing unit 721 of electrical signals representing data bits which causes a resulting transformation or reduction of the electrical signal representation, and the maintenance of data bits at memory locations in the memory system (including the system memory 722, hard drive 727, floppy disks 729, and CD-ROM 731) to thereby reconfigure or otherwise alter the computer system's operation, as well as other processing of signals. The memory locations wherein such data bits are maintained are physical locations that have particular electrical, magnetic, or optical properties corresponding to the data bits.

Referring to FIG. 38, a diagram of an exemplary computerized device 800 that can be employed in conjunction with various aspects of the present invention is illustrated. The computerized device 800 can be, for example, a desktop computer, a laptop computer, a personal digital assistant (PDA), a cell phone, etc.; the invention is not so limited. Those skilled in the art will appreciate that the invention may be practiced with other computer system configurations, including hand-held devices, multiprocessor systems, microprocessor-based or programmable consumer electronics, network PC's, minicomputers, mainframe computers, and the like. The invention may also be practiced in distributed computing environments wherein tasks are performed by remote processing devices that are linked through a communications network.

The device 800 includes one or more of the following components: processor(s) 802, memory 804, storage 806, a communications component 808, input device(s) 810, a display 812, and output device(s) 814. It is noted, that for a particular instantiation of the device 800, one or more of these components may not be present. For example, a PDA may not have any output device(s) 814, while a cell phone may not have storage 806, etc. Thus, the description of the device 800 is to be utilized as an overview as to the types of components that typically reside within such a device 800, and is not meant as a limiting or exhaustive description of such computerized devices.

The processor(s) 802 may include a single central-processing unit (CPU), or a plurality of processing units, commonly referred to as a parallel processing environment. The memory 804 may include read only memory (ROM) and/or random access memory (RAM). The storage 806 may be any type of storage, such as fixed-media storage devices such as hard disk drives, flash or other non-volatile memory, as well as removable-media storage devices, such as tape drives, optical drives like CD-ROM's, floppy disk drives, etc. The storage and their associated computer-readable media provide non-volatile storage of computer-readable instructions, data structures, program modules and other data. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be employed.

Because the device 800 may operate in a network environment, such as the Internet, intranets, extranets, local-area networks (LAN's), wide-area networks (WAN's), etc., a communications component 808 can be present in or attached to the device 800. Such a component 808 may be one or more of a network card, such as an Ethernet card, an analog modem, a cable modem, a digital subscriber loop (DSL) modem, an Integrated Services Digital Network (ISDN) adapter, etc.; the invention is not so limited. Furthermore, the input device(s) 810 are the mechanisms by which a user indicates input to the device 800. Such device(s) 810 include keyboards, pointing devices, microphones, joysticks, game pads, satellite dishes, scanners, etc. The display 812 is how the device 800 typically directs output to the user, and can include, for example, cathode-ray tube (CRT) display devices, flat-panel display (FPD) display devices, etc. In addition, the device 800 may indicate output to the user via other output device(s) 814, such as speakers, printers, etc.

What has been described above are preferred aspects of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations and variations that fall within the spirit and scope of the appended claims.

What is claimed is:

1. A notification system, comprising:
a monitor that monitors likely available states of an entity; and
a bounding system that classifies a notification to the entity according to a predefined protocol and the likely available states, the bounding system facilitating deferral of the notification based at least in part on the notification classification.

2. The system of claim 1, wherein the bounding system is a subscription service provided at a notification source that enables users to tag notifications according to a predefined priority.

3. The system of claim 2, wherein the predefined priority is assigned based upon the happening of a condition.

4. The system of claim 2, further comprising a subscription user interface to enable users to configure attributes of a notification.

5. The system of claim 4, wherein the attributes are defined in a notification schema.

6. The system of claim 5, the notification schema further comprising at least one of a notification class, a source, a source assigned priority, a sender, a target, one or more content components, a relevant context, and advanced attributes.

7. The system of claim 5, further comprising a preferences profile for assigning priority based upon settings in the notification schema.

8. The system of claim 7, further comprising a notification preferences editor to enable users to configure the preferences profile.

9. The system of claim 8, wherein the notification preference editor enables users to configure at least one of a context, a source type, a contact class, and a notification agent policy for directing received notifications.

10. The system of claim 9, wherein the context includes at least one of a calendar, time of day, and a device activity.

11. The system of claim 9, wherein the source type includes at least one of a human contact and an automated alert.

12. The system of claim 9, wherein the contact class includes at least one of key associates, family, and an InAddress Book.

13. The system of claim 1, wherein the monitor derives context from at least one of a calendar, a time of day, a device activity, and a user location.

14. The system of claim 13, wherein the monitor determines the likely available states from the derived context.

15. The system of claim 1, wherein the likely available states are determined from at least one of an indication by the user, an office setting, an environment setting, an activity setting, and a driving setting.

16. The system of claim 1, further comprising a notification agent that directs notifications from one or more sources to one or more notification sinks based at least in part on the predefined protocol and the likely available states.

17. The system of claim 1, wherein the bounding system is a priorities system that automatically assigns priorities to notifications.

18. The system of claim 17, wherein the priorities are assigned via a classifier.

19. The system of claim 1, further comprising a max deferral setting that is associated with a notification priority to enable at least one of a delivery of the notification at a time-out of the max deferral, and deferral of the notification to the likely available free state.

20. The system of claim 19, further comprising a setting to enable designated notifications to at least one of be passed-through, and restricted during designated periods.

21. A method to minimize notification disruption costs, comprising,
tagging one or more notifications with a value;
determining available user states;
defining one or more time bounds based upon the value; and
deferring the one or more notifications until at least one of the available user states, and the one or more time bounds.

22. The method of claim 21, wherein the value is at least one of automatically assigned and manually assigned.

23. The method of claim 22, wherein the value is at least one of a priority, an urgency, and an importance.

24. The method of claim 23, wherein the value is at least one of a scalar number, a dollar ($$) value, and a qualitative tag.

25. The method of claim 23, wherein the value reflects the change in value over time with delays.

26. The method of claim 25, wherein the value is determined as expressions of deadlines, stepwise, half-life, and sigmoid functions.

27. The method of claim 21, wherein determining available user states further comprises at least one of:
detecting typing and a pause for x seconds;
detecting a file operation and a pause for x seconds;
detecting an e-mail transmission and a pause for x seconds;
detecting an application close operation;
detecting a switch from one application to another; and
detecting a reduction in a user's conversation.

28. The method of claim 21, wherein determining available user states is directed by a user.

29. The method of claim 28, wherein determining available user states further comprises at least one of:
providing a user specified pause after typing;
specifying availability after an e-mail;
specifying availability after a file operation; and
specifying availability after a conversation.

30. A computer-readable medium having computer-executable instructions to perform the acts of claim 21.

31. A system to minimize disruption costs, comprising,
means for tagging one or more messages with a value;
means for determining available free states;
means for specifying one or more time bounds based upon the value; and
means for deferring the one or more messages until at least one of the available free states, and the one or more time bounds.

32. The system of claim 31, wherein the means for tagging includes at least one of a subscription service and a priorities system.

33. A method to display notifications, comprising,
chunking of notifications; and
displaying the chunks based upon a likely free state and as ordered by at least one of priority, age, and priority by group.

34. A notification system, comprising:
a context monitor that monitors likely available states of an entity; and
a notification agent that classifies a notification to the entity according to a max deferral and the likely available states, the notification agent facilitating deferral of the notification based at least in part on the notification classification.

35. The system of claim 34, wherein the max deferral is expressed as:
max deferral(priority)=e^{-k(priority)}.

36. A method to journal notifications, comprising:
maintaining a global journal for one or more notifications;
providing a more detailed notification window within the journal; and
providing notifications to at least one of the global journal and the notification window based upon one or more bounded notification deferral policies.

37. The method of claim 36, further comprising,
providing at least one of highlighted links, advertisements, and branding information within the notification window.

38. The method of claim 36, further comprising,
removing notifications from a queue based upon at least one of an expired time and date.

39. A method to associate priority information with messages, comprising:
appending a priority value to one or more notifications;
tagging the one or more notifications with application-specific contexts from a set of contexts; and
rendering the one or more notifications within an active context from the set of contexts.

40. A method to determine available users states in a notification system, comprising:
determining a frequency users are available at a desktop;
determining a frequency when alerts are received by the user; and
inferring an expected time until a next likely free state.

41. A method to provide mobile notifications, comprising:
inferring one or more available free states from a mobile device; and
sending notifications to a user based upon at least one of the one or more available free states and a bounded deferral policy.

42. The method of claim 41, further comprising,
detecting an away state; and
relaying the one or more notifications to a mobile notification journal.

43. The method of claim 42, further comprising,
posting notifications to a desktop computer during the away state.

44. The method of claim 42, further comprising,
providing a display upon return policy to control timing of the one or more notifications.

45. A tool for configuring deferral policies, comprising:
a user interface to assess one or more points of mapping a continuous priority to a function that yields a deferral bound via extrapolation from one or more other points; and
one or more inputs associated with the user interface to adjust the deferral policies.

46. The tool of claim 45, further comprising at least one of a deadline adjustment field, a context field, and a fallback field.

47. The tool of claim 46, the context field including context inputs to change deferral times for different urgencies of one or more items.

48. The tool of claim 47, the context inputs including at least one of busy working, meeting, critical meeting, and after hours.

49. The tool of claim 46, the fallback field including at least one of send immediately, try best to wait for a good time, but never go over a deadline, and allow a deadline to pass, but wait for a good time.

50. A method providing bounded deferral of communications, comprising:
determining changes in a user's activities;
determining an availability state based upon the user's activities; and
providing prioritized information to the user based upon the availability state.

51. The method of claim 50, the activities includes at least one of bicycling, driving, and being at a presentation.

52. The method of claim 50, the activities determined via at least one of accelerometers, monitors to discover when a user has stopped, waiting for a pause in driving load, detecting a stop at a stop sign, detecting a longer pause associated with completing a park, waiting at a red light, and waiting for noise coupled with calendar information about the end of a presentation.

53. The method of claim 50, wherein determining the availability state is based on at least one of sensed and predicted completion of a task, a break or pause in desktop activities, a break in office collaboration activities.

54. The method of claim 50, wherein determining the availability state is based on at least one of timing, forecasting, inference, and direct monitoring.
